(19) United States
(12) Patent Application Publication
(10) Pub. No.: US 2026/0333360 A1
(43) Pub. Date: Oct. 22, 2026

(54) INTERFERENCE MITIGATION FOR SUBBAND FULL DUPLEX OPERATION WITH MULTIPLE RADIO ACCESS TECHNOLOGIES

(71) Applicant: Lenovo (United States) Inc., Morrisville, NC (US)

(72) Inventors: Khaled Nafez Rauf Ardah, Ilmenau (DE); Karthikeyan Ganesan, Nauheim (DE)

(73) Assignee: Lenovo (United States) Inc., Morrisville, NC (US)

(21) Appl. No.: 19/382,015

(22) Filed: Nov. 6, 2025

(51) Int. Cl. H04W 72/21; H04L 5/14

(52) U.S. Cl. CPC H04W 72/21; H04L 5/14

(57) ABSTRACT

Various aspects of the present disclosure relate to interference mitigation for subband full duplex (SBFD) operation with multiple radio access technologies (RATs). A first user equipment (UE) receives first signaling that indicates an SBFD configuration indicating an uplink subband and a downlink subband associated with a first RAT. The SBFD configuration operates on a shared time division duplex (TDD) carrier associated with the first RAT and a second RAT different from the first RAT. The first UE receives second signaling that indicates one or more parameters to minimize an interference between the first UE and a second UE when operating on the shared TDD carrier. The first UE is associated with the first RAT, and the second UE is associated with the second RAT. The first UE transmits an uplink transmission to a network equipment (NE) associated with the first RAT based on the one or more parameters.

### TECHNICAL FIELD

The present disclosure relates to wireless communications, and more specifically to interference mitigation techniques.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive first signaling that indicates a subband full duplex (SBFD) configuration including at least one uplink subband and at least one downlink subband associated with a first radio access technology (RAT), where the SBFD configuration operates on a shared time division duplex (TDD) carrier associated with the first RAT and a second RAT different from the first RAT, receive second signaling that indicates one or more parameters to minimize an interference between the first UE and a second UE when operating on the shared TDD carrier, where the first UE is associated with the first RAT, and where the second UE is associated with the second RAT, and transmit, to an NE associated with the first RAT, an uplink transmission based on the one or more parameters.

A processor (e.g., a standalone processor chipset, or a component of a UE) for wireless communication is described. The processor may be configured to, capable of, or operable to perform one or more operations as described herein. For example, the processor may be configured to, capable of, or operable to receive first signaling that indicates an SBFD configuration indicating at least one uplink subband and at least one downlink subband associated with a first RAT, where the SBFD configuration operates on a shared TDD carrier associated with the first RAT and a second RAT different from the first RAT, receive second signaling that indicates one or more parameters to minimize an interference between the first UE and a second UE when operating on the shared TDD carrier, where the first UE is associated with the first RAT, and where the second UE is associated with the second RAT, and transmit, to an NE associated with the first RAT, an uplink transmission based on the one or more parameters.

A method performed or performable by a UE for wireless communication is described. The method may include receiving first signaling that indicates an SBFD configuration indicating at least one uplink subband and at least one downlink subband associated with a first RAT, where the SBFD configuration operates on a shared TDD carrier associated with the first RAT and a second RAT different from the first RAT, receiving second signaling that indicates one or more parameters to minimize an interference between the first UE and a second UE when operating on the shared TDD carrier, where the first UE is associated with the first RAT, and where the second UE is associated with the second RAT, and transmitting, to an NE associated with the first RAT, an uplink transmission based on the one or more parameters.

In some implementations of the UE, the processor, and the method described herein, the one or more parameters include an indication of at least one uplink resource muting pattern based on one or more time and frequency resources corresponding to a downlink transmission associated with the second UE, and to transmit the uplink transmission, the method may further be configured to, capable of, or operable to mute the uplink transmission on the one or more time and frequency resources. In some implementations, the UE, the processor, and the method may further be configured to, capable of, or operable to receive, prior to the second signaling, third signaling that indicates a set of uplink resource muting patterns including the at least one uplink resource muting pattern, and where the one or more parameters include an index corresponding to the at least one uplink resource muting pattern. In some implementations, the at least one uplink resource muting pattern includes one or more bitmaps, an offset in a frequency domain to apply the at least one uplink resource muting pattern, an offset in a time domain to apply the at least one uplink resource muting pattern, a starting resource in the time domain to apply the at least one uplink resource muting pattern, a periodicity to apply the at least one uplink resource muting pattern, a periodicity level to apply the at least one uplink resource muting pattern, an uplink bandwidth part (BWP) index to apply the at least one uplink resource muting pattern, an SBFD pattern index to apply the at least one uplink resource muting pattern, a panel index to apply the at least one uplink resource muting pattern, or a beam index to apply the at least one uplink resource muting pattern.

In some implementations of the UE, the processor, and the method described herein, the one or more parameters include an offset in at least one of a time domain or a frequency domain based on a downlink transmission associated with the second UE, and to transmit the uplink transmission, the UE, the processor, and the method may further be configured to, capable of, or operable to apply the offset to one or more time or frequency resources associated with the uplink transmission. In some implementations of the UE, the processor, and the method described herein, the one or more parameters include an indication to drop at least one of the uplink transmission or a repetition of the uplink transmission based on the uplink transmission or the repetition of the uplink transmission overlapping with a downlink transmission associated with the second UE, and to transmit the uplink transmission, the UE, the processor, and the method may further be configured to, capable of, or operable to drop at least one of the uplink transmission or the repetition of the uplink transmission. In some implementations of the UE, the processor, and the method described herein, the one or more parameters include a reference priority value that is based on the downlink transmission associated with the second UE, and to drop at least one of the uplink transmission or the repetition of the uplink transmission, the UE, the processor, and the method may further be configured to, capable of, or operable to determine a priority value associated with at least one of the uplink transmission or the repetition of the uplink transmission is greater than the reference priority value.

In some implementations of the UE, the processor, and the method described herein, the one or more parameters include an indication of at least one of a power offset value or a maximum transmit power limit, and to transmit the uplink transmission, the UE, the processor, and the method may further be configured to, capable of, or operable to apply at least one of the power offset value or the maximum transmit power limit to a transmit power associated with the uplink transmission. In some implementations of the UE, the processor, and the method described herein, the one or more parameters include an indication of at least one of a beam index, a transmission configuration indicator (TCI) state indicator, or a panel switch indicator, and to transmit the uplink transmission, the UE, the processor, and the method may further be configured to, capable of, or operable to switch at least one of a first panel to a second panel associated with the panel switch indicator or a first uplink transmit beam to a second uplink transmit beam associated with at least one of the beam index or the TCI state indicator. In some implementations of the UE, the processor, and the method described herein, the one or more parameters include an indication of an update to at least one of an uplink subband time or a frequency dimension associated with the uplink transmission, and to transmit the uplink transmission, the UE, the processor, and the method may further be configured to, capable of, or operable to revert, based on the update, one or more of an uplink resource block (RB) to a downlink RB corresponding to a downlink transmission associated with the second UE or an SBFD time resource to a non-SBFD time resource.

In some implementations of the UE, the processor, and the method described herein, the UE, the processor, and the method may further be configured to, capable of, or operable to receive, prior to the second signaling, third signaling that indicates a set of SBFD patterns, where the one or more parameters include an indication of an SBFD pattern of the set of SBFD patterns that includes one or more first time and frequency resources corresponding to the uplink transmission, and where the SBFD pattern is based on minimizing an overlap between the one or more first time and frequency resources and one or more second time and frequency resources corresponding to a downlink transmission associated with the second UE. In some implementations of the UE, the processor, and the method described herein, the UE, the processor, and the method may further be configured to, capable of, or operable to receive, prior to the second signaling, third signaling that indicates a set of uplink BWPs, where the one or more parameters indicate an uplink BWP of the set of uplink BWPs associated with the uplink transmission, and where the uplink BWP is based on minimizing an overlap between one or more first time and frequency resources corresponding to the uplink transmission and one or more second time and frequency resources corresponding to a downlink transmission associated with the second UE. In some implementations of the UE, the processor, and the method described herein, the uplink transmission is transmitted in the at least one uplink subband of the SBFD configuration, where a downlink configuration associated with the second UE overlaps at least in part with the SBFD configuration on the shared TDD carrier, and where the first RAT includes a 6G RAT and the second RAT includes 5G RAT.

An NE (e.g., a base station) for wireless communication is described. The NE may be configured to, capable of, or operable to perform one or more operations as described herein. For example, the NE may be configured to, capable of, or operable to transmit first signaling that indicates an SBFD configuration indicating at least one uplink subband and at least one downlink subband associated with a first RAT, where the SBFD configuration operates on a shared TDD carrier associated with the first RAT and a second RAT different from the first RAT, transmit second signaling that indicates one or more parameters to minimize an interference between a first UE and a second UE when operating on the shared TDD carrier, where the first UE is associated with the first RAT, and where the second UE is associated with the second RAT, and receive, from the first UE, an uplink transmission based on the one or more parameters, where the NE is associated with the first RAT.

A processor (e.g., a standalone processor chipset, or a component of an NE) for wireless communication is described. The processor may be configured to, capable of, or operable to perform one or more operations as described herein. For example, the processor may be configured to, capable of, or operable to transmit first signaling that indicates an SBFD configuration indicating at least one uplink subband and at least one downlink subband associated with a first RAT, where the SBFD configuration operates on a shared TDD carrier associated with the first RAT and a second RAT different from the first RAT, transmit second signaling that indicates one or more parameters to minimize an interference between a first UE and a second UE when operating on the shared TDD carrier, where the first UE is associated with the first RAT, and where the second UE is associated with the second RAT, and receive, from the first UE, an uplink transmission based on the one or more parameters, where the NE is associated with the first RAT.

A method performed or performable by an NE (e.g., a base station) for wireless communication is described. The method may include transmitting first signaling that indicates an SBFD configuration indicating at least one uplink subband and at least one downlink subband associated with a first RAT, where the SBFD configuration operates on a shared TDD carrier associated with the first RAT and a second RAT different from the first RAT, transmitting second signaling that indicates one or more parameters to minimize an interference between a first UE and a second UE when operating on the shared TDD carrier, where the first UE is associated with the first RAT, and where the second UE is associated with the second RAT, and receiving, from the first UE, an uplink transmission based on the one or more parameters, where the NE is associated with the first RAT.

In some implementations of the NE, the processor, and the method described herein, the NE, the processor, and the method may further be configured to, capable of, or operable to receive, from an additional NE associated with the second RAT, scheduling information corresponding to a downlink transmission associated with the second UE, and select at least one uplink resource muting pattern based on minimizing an overlap between one or more first time and frequency resource associated with the uplink transmission and one or more second time and frequency resources associated with the downlink transmission, where the one or more parameters include an indication of the at least one uplink resource muting pattern, and where the uplink transmission is muted on the one or more second time and frequency resources. In some implementations of the NE, the processor, and the method described herein, the NE, the processor, and the method may further be configured to, capable of, or operable to transmit, prior to the second signaling, third signaling that indicates a set of uplink resource muting patterns including the at least one uplink resource muting pattern, and where the one or more parameters include an index corresponding to the at least one uplink resource muting pattern. In some implementations of the NE, the processor, and the method described herein, the at least one uplink resource muting pattern includes one or more bitmaps, an offset in a frequency domain to apply the at least one uplink resource muting pattern, an offset in a time domain to apply the at least one uplink resource muting pattern, a starting resource in the time domain to apply the at least one uplink resource muting pattern, a periodicity to apply the at least one uplink resource muting pattern, a periodicity level to apply the at least one uplink resource muting pattern, an uplink BWP index to apply the at least one uplink resource muting pattern, an SBFD pattern index to apply the at least one uplink resource muting pattern, a panel index to apply the at least one uplink resource muting pattern, or a beam index to apply the at least one uplink resource muting pattern.

In some implementations of the NE, the processor, and the method described herein, the one or more parameters include an indication of an offset in at least one of a time domain or a frequency domain based on a downlink transmission associated with the second UE, and to receive the uplink transmission, the NE, the processor, and the method may further be configured to, capable of, or operable to apply the offset to one or more time or frequency resources associated with the uplink transmission. In some implementations of the NE, the processor, and the method described herein, the one or more parameters include an indication to drop at least one of the uplink transmission or a repetition of the uplink transmission based on the uplink transmission or the repetition of the uplink transmission overlapping with a downlink transmission associated with the second UE, and at least one of the uplink transmission or the repetition of the uplink transmission is dropped. In some implementations of the NE, the processor, and the method described herein, the one or more parameters include a reference priority value that is based on the downlink transmission associated with the second UE. In some implementations of the NE, the processor, and the method described herein, the one or more parameters include at least one of a power offset value or a maximum transmit power limit. In some implementations, the one or more parameters include at least one of a beam index, a TCI state indicator, or a panel switch indicator.

In some implementations of the NE, the processor, and the method described herein, the one or more parameters include an indication of an update to at least one of an uplink subband time or a frequency dimension associated with the uplink transmission, and to receive the uplink transmission, the NE, the processor, and the method may further be configured to, capable of, or operable to revert, based on the update, one or more of an uplink RB to a downlink RB corresponding to a downlink transmission associated with the second UE or an SBFD time resource to a non-SBFD time resource. In some implementations of the NE, the processor, and the method described herein, the NE, the processor, and the method may further be configured to, capable of, or operable to transmit, prior to the second signaling, third signaling that indicates a set of SBFD patterns, where the one or more parameters include an indication of an SBFD pattern of the set of SBFD patterns that includes one or more first time and frequency resources corresponding to the uplink transmission, and where the SBFD pattern is based on minimizing an overlap between the one or more first time and frequency resources and one or more second time and frequency resources corresponding to a downlink transmission associated with the second UE. In some implementations of the NE, the processor, and the method described herein, the NE, the processor, and the method may further be configured to, capable of, or operable to transmit, prior to the second signaling, third signaling that indicates a set of uplink BWPs, where the one or more parameters indicate an uplink BWP of the set of uplink BWPs associated with the uplink transmission, and where the uplink BWP is based on minimizing an overlap between one or more first time and frequency resources corresponding to the uplink transmission and one or more second time and frequency resources corresponding to a downlink transmission associated with the second UE. In some implementations of the NE, the processor, and the method described herein, the uplink transmission is transmitted in the at least one uplink subband of the SBFD configuration, where a downlink configuration associated with the second UE overlaps at least in part with the SBFD configuration on the shared TDD carrier, and where the first RAT includes a 6G RAT and the second RAT includes 5G RAT.

### BRIEF DESCRIPTION OF THE DRAWINGS

FIG. 1 illustrates an example of a wireless communications system in accordance with aspects of the present disclosure.

FIGS. 2 and 3 illustrate examples of resource diagrams, in accordance with aspects of the present disclosure.

FIG. 4 illustrates an example of a wireless communications system, in accordance with aspects of the present disclosure.

FIG. 5 illustrates an example of a signaling diagram, in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

In a wireless communications system, a UE and an NE (e.g., a base station, a gNB) may support transmission and reception of signaling, referred to as wireless communication, using one or more RATs. A RAT may define a set of protocols, standards, and procedures that enable the wireless communication between the UE and the NE, where RATs (e.g., 4G LTE, 5G new radio (NR), and 6G) may utilize different configurations for the wireless communication, different modulation schemes, and different resource allocation techniques. In some cases, the wireless communications system may include one or more NEs and/or UEs that operate with different RATs simultaneously within a same geographic area. For example, a wireless communications system may include a first NE that supports 5G NR wireless communications and a second NE that supports 6G wireless communications, where both NEs may provide coverage within overlapping or adjacent coverage areas. A first UE may be configured to communicate with the first NE using 5G NR protocols, while a second UE may be configured to communicate with the second NE using 6G protocols.

In some cases, the wireless communications system may support spectrum sharing between the RATs, where both RATs may operate on a shared TDD carrier to improve spectrum efficiency. A shared TDD carrier may be a frequency band or spectrum resource that supports wireless communications for multiple RATs, where the carrier alternates between uplink and downlink transmissions in time intervals and may be accessed by UEs and NEs of different RATs. In some cases, the wireless communications system may include an NE (e.g., a 6G NE) operating in an SBFD mode on a shared TDD carrier, where the NE simultaneously transmits and receives signals on different frequency subbands within a same time interval in an SBFD mode. In some cases, the shared TDD carrier may support communications for both the 6G RAT and a different RAT, such as 5G NR, where the 5G NR may operate using TDD scheduling that alternates between uplink and downlink transmissions in a time domain. The coexistence of SBFD operation for 6G and TDD operation for 5G on a shared TDD carrier may cause interference, including cross-link interference (CLI). The CLI occurs when uplink and downlink transmissions occur at a same time (e.g., concurrently) on one or more same or overlapping frequency resources, causing signal degradation. CLI may manifest in various forms, including UE-to-UE interference where an uplink transmission from a UE interferes with a downlink reception at another UE, or NE-to-NE interference where a downlink transmission from one NE interferes with an uplink reception at another NE. In the context of multi-RAT spectrum sharing with SBFD operation, CLI may occur when a 6G UE performing uplink transmission in an SBFD uplink subband interferes with a 5G UE attempting to receive downlink signals on overlapping frequency resources, or when a 6G NE transmitting downlink signals in an SBFD downlink subband interferes with a 5G NE attempting to receive uplink signals from a 5G UE on the same frequency resources.

As described herein, to mitigate interference caused by multi-RAT spectrum sharing with SBFD operation, a UE operating using a 6G RAT may receive interference mitigation parameters from an NE and may apply the parameters to an uplink transmission to minimize interference with a downlink reception at another UE operating using a 5G RAT when both RATs share a same TDD carrier. The UE operating using the 6G RAT may receive signaling from the NE that indicates an SBFD configuration indicating one or more frequency subbands within the shared TDD carrier in which the UE may simultaneously transmit uplink signals and receive downlink signals. The UE may receive additional signaling including the interference mitigation parameters, which may include resource muting patterns to mute an uplink transmission on one or more time and frequency resources where the other UE is receiving downlink signals, time and/or frequency offsets to shift uplink transmission resources away from conflicting resource allocations, updated transmit power levels or maximum power limits to reduce interference levels, updated transmission beams or antenna panels to direct signals away from interfering paths, and/or updated SBFD patterns or BWP configurations to minimize resource overlap, among other examples. The UE may determine an uplink subband within the SBFD configuration for transmitting the uplink transmission. Then, the UE may apply the interference mitigation parameters to the uplink transmission within the uplink subband. For example, the UE may select one or more time and frequency resources within the uplink subband utilizing the SBFD configuration, and then may apply resource muting patterns, power adjustments, beam configurations, or other interference mitigation techniques indicated by the parameters to reduce interference with downlink transmissions to the other UE (e.g., a 5G NR UE) operating on overlapping frequency resources of the shared TDD carrier.

By performing the described techniques, a device (e.g., a UE and/or an NE) in a wireless communications system can provide for improved interference mitigation for multi-RAT spectrum sharing. For example, an NE can configure a UE to apply one or more interference mitigation parameters that minimize interference between the UE and another UE operating using a different RAT on a shared TDD carrier. The UE may achieve the interference mitigation through resource coordination, where resource muting patterns reduce or prevent simultaneous transmission and reception on overlapping time-frequency resources and/or power control mechanisms reduce signal strength in communication scenarios with relatively high interference (e.g., greater than a threshold interference), among other examples. Additionally, or alternatively, the UE may implement spatial separation techniques using beam switching and panel selection to direct transmission energy away from other UEs and/or dynamic SBFD pattern adaptation to update subband allocations to minimize resource conflicts between different RATs operating on a shared TDD carrier.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

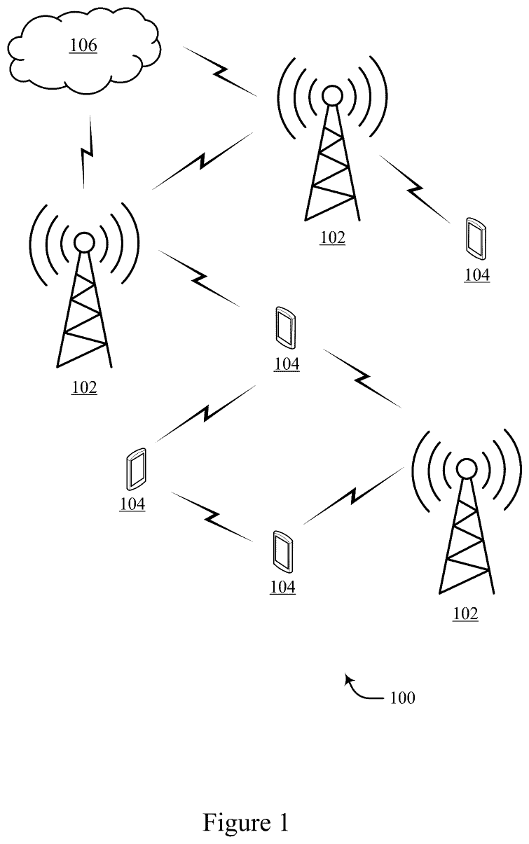

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some examples, the wireless communications system 100 may support multi-RAT operation, in which multiple RATs operate within a same geographic area or on shared spectrum resources (e.g., one or more resources in a frequency domain). For example, one or more devices (e.g., UEs 104 and/or NEs 102) in 6G networks may share one or more frequency band carriers with one or more devices in 5G NR networks using a multi-RAT spectrum sharing (MRSS) scheme due to there being finite available free spectrum. The available free spectrum may be at one or more lower frequency bands (e.g., below 6 GHz) where 5G NR is already deployed. The multi-RAT operation may enable enhanced spectrum efficiency, improved coverage, and seamless service continuity as wireless networks evolve from one generation to the next. In some cases, the multi-RAT scenarios may involve coexistence of 5G NR and 6G technologies, where both RATs may operate simultaneously to serve different types of UEs 104 or to provide different service capabilities within overlapping coverage areas. Additionally, or alternatively, the multi-RAT operation may include combinations of other wireless technologies, such as 4G LTE, Wi-Fi (IEEE 802.11), WiMAX (IEEE 802.16), or future generations beyond 6G. The multi-RAT scenarios may also include different deployment architectures, including macro-cell and small-cell deployments, indoor and outdoor coverage scenarios, licensed and unlicensed spectrum utilization, and various network slicing configurations to support diverse service criterion, such as enhanced mobile broadband (eMBB), ultra-reliable low-latency communications (URLLC), and massive machine-type communications (mMTC).

In some examples, the devices in the wireless communications system 100 may achieve the MRSS scheme via various processes, including by time or frequency domain multiplexing techniques (e.g., by dividing time domain and/or frequency domain resources of a shared carrier between a 6G network and a 5G NR network). However, time or frequency domain multiplexing techniques may cause inefficient use of time and frequency resources (e.g., a resource wastage), due to an inability to capture and adapt divided resource with real time traffic variations, demands, and load between different RATs and/or cells in the wireless communications system 100. In some other examples, the 6G network may share a same band and/or carrier spectrum (e.g., dynamically and/or semi-statically) with a 5G-NR network according to real time traffic demands, while avoiding or minimizing a negative impact towards the 5G NR networks.

In some examples, the multi-RAT scenario may include a single NE 102 that supports (e.g., enables, provides, facilitates) both 5G and 6G RATs concurrently. For example, an NE 102 may be configured with dual-RAT capabilities, enabling the NE 102 to serve both 5G UEs and 6G UEs within a same coverage area. In some other examples, the multi-RAT scenario may include multiple NEs 102 that each support different RATs (e.g., an NE 102 that supports a 5G RAT and a different NE 102 that supports a 6G RAT). Additionally, or alternatively, the multi-RAT scenario may include UEs 104 that each support a different RAT or are capable of supporting multiple RATs concurrently. For example, a UE 104 with multi-RAT capabilities that can switch between or simultaneously support both 5G and 6G communications. In some other examples, a UE 104 may support a single RAT, such as 5G or 6G communications. An NE 102 may allocate (e.g., configure, schedule, indicate, assign, distribute) different time and frequency resources to each RAT or may implement interference management techniques to enable simultaneous operation of both RATs on shared spectrum resources. For example, the NE 102 may coordinate (e.g., manage, control) wireless communications between UEs 104 operating under different RATs to reduce or minimize inter-RAT interference and improve overall performance of the wireless communications system 100. Although reference is made herein to 5G and 6G, the NEs 102 and/or the UEs 104 in the wireless communications system 100 may support any numerical quantity or type of RATs, such as 4G, 5G, and 6G, or combinations including Wi-Fi and cellular technologies.

In some cases, the multi-RAT operation may include spectrum sharing, in which different RATs utilize the same frequency bands through coordinated scheduling or dynamic spectrum access (e.g., orthogonal resource allocation, semi-orthogonal resource allocation, or non-orthogonal resource allocation). For example, a shared TDD carrier may support both 5G NR communications using TDD scheduling and 6G communications using SBFD operation, where a device (e.g., an NE 102 and/or a UE 104) operating using the 6G RAT may simultaneously transmit and receive on different frequency subbands within a same time interval. A shared TDD carrier may include a frequency band or spectrum resource that supports TDD operation for multiple RATs, where the carrier alternates between uplink and downlink transmissions in time intervals and may be accessed by UEs 104 and NEs 102 of different RATs. The spectrum sharing may occur between 5G and 6G technologies, 4G and 5G technologies, Wi-Fi and cellular technologies (e.g., the 4G, 5G, and/or 6G technologies) operating in unlicensed bands, satellite and terrestrial networks sharing common frequency allocations, or combinations of licensed and unlicensed spectrum access. The spectrum sharing may be facilitated (e.g., enabled, supported, assisted) through coordination between NEs 102 serving different RATs. For example, the NEs 102 may exchange (e.g., share, communicate, transmit) scheduling information and/or interference management parameters to improve resource utilization and minimize cross-RAT interference. The NEs 102 may coordinate via one or more interfaces, such as X2 or Xn interfaces in cellular networks.

In some examples, one or more devices in the wireless communications system 100 may operate in an SBFD mode (e.g., a semi-static SBFD mode), as well as frequency division duplex (FDD) and TDD modes. For example, one or more NEs 102 and/or UEs 104 that operate using a 6G RAT in the wireless communications system 100 may support SBFD operation, which enables simultaneous transmission and reception of signals on different frequency subbands within a same time interval. For SBFD operation, a carrier bandwidth is divided into multiple subbands with some subbands allocated for uplink transmissions and other subbands allocated for downlink transmissions during a same time period. An SBFD mode may be operational on a TDD carrier, where the frequency domain resources of one or more downlink and/or flexible symbols are partitioned (e.g., split, segmented, divided) into multiple subbands. A subband is a portion or subdivision of a carrier bandwidth that represents a defined frequency range within an overall spectrum allocation, where multiple subbands can be configured for different transmission directions (e.g., uplink or downlink) or different communication purposes within a same time interval. One or more of the multiple subbands may be allocated for uplink transmissions while other subbands may be allocated for downlink transmissions during the same time period. In some cases, at most one of the subbands is allocated as uplink and used for uplink communications. In some examples, an NE 102 may dynamically adjust (e.g., update, modify, adapt, reconfigure) the SBFD configuration according to traffic demands, channel conditions, and/or interference scenarios. For example, if a volume of downlink traffic exceeds a threshold value, then an NE 102 may allocate more subbands to downlink transmission. If a volume of uplink traffic exceeds a threshold value, then the NE 102 may allocate more subbands to uplink transmission.

In a shared TDD carrier supporting multiple RATs, a device using a first RAT may operate in an SBFD mode, while a device using a second RAT may continue to use TDD scheduling. For example, a shared TDD carrier may support 5G and 6G RATs, and a 6G NE may operate in the SBFD mode, while a 5G NE and/or a 5G UE may operate using TDD scheduling (e.g., not in an SBFD mode). In some examples, if a 6G NE and/or cell employs an SBFD mode, then an associated inter-RAT (e.g., inter-band/intra-band) inter-UE CLI originating from the 6G NE and/or cell may impact UEs connected to a 5G NR NE and/or cell. The 6G NE may simultaneously transmit (e.g., send, broadcast, communicate) downlink signals to 6G UEs on one or more frequency subbands and receive uplink signals from other 6G UEs on different frequency subbands within a same time slot, causing CLI at a 5G UE attempting to receive downlink transmissions when uplink transmissions from a 6G UE occur simultaneously on adjacent or overlapping frequency resources.

Interference refers to signals or noise that disrupt, degrade, or negatively affect the quality of wireless communications, causing reduced signal-to-interference-plus-noise ratio (SINR), decreased data throughput, increased packet error rates, and compromised communication performance. In some cases, UE-to-UE CLI occurs when an uplink transmission from a 6G UE operating in an SBFD uplink subband interferes (e.g., disrupts, degrades, affects) with downlink reception at a nearby 5G UE attempting to receive signals on overlapping frequency resources during the same time slot. Additionally, or alternatively, NE-to-NE CLI occurs when downlink transmissions from a 6G base station operating in an SBFD downlink subband interfere with uplink reception at a 5G base station attempting to receive signals from one or more served UEs on the same frequency resources. Additional interference types include adjacent subband leakage, where out-of-band emissions from SBFD uplink subbands interfere with downlink reception in neighboring frequency subbands, reciprocal interference caused by imperfect isolation between transmit and receive chains within the same SBFD device, and temporal interference occurring during SBFD pattern transitions when switching between different subband configurations. The impact of the interference on a signal may depend on geographical proximity of devices, transmission power levels, antenna patterns, and/or propagation characteristics (e.g., including multipath fading, shadowing effects, and Doppler shifts), among other example factors. The interference caused by the SBFD operation on the shared TDD carrier may result in performance degradation, including reduced SINR levels that can lead to decreased data throughput, increased packet error rates, and higher retransmission overhead for affected communications. In some cases, the interference may cause communication link failures or cause UEs 104 to fall back to lower-order modulation schemes, thereby reducing overall system capacity and compromising quality of service on the shared TDD carrier.

According to examples, one or more of the NEs 102 and the UEs 104 are operable to implement various aspects of the techniques described with reference to the present disclosure. The wireless communications system 100 implements interference mitigation techniques to minimize interference between devices (e.g., CLI between UEs 104) that utilize different RATs for SBFD operation on a shared TDD carrier. In some cases, an NE 102 transmits an SBFD configuration indicating at least one uplink subband and at least one downlink subband for a first RAT. The SBFD configuration operates on a TDD carrier that is shared for the first RAT and a second RAT different from the first RAT (e.g., 5G and 6G). The NE 102 may also transmit one or more parameters to minimize (e.g., reduce, mitigate, decrease) interference between a first UE and a second UE when operating on the shared TDD carrier. The first UE utilizes the first RAT, and the second UE utilizes the second RAT. The parameters include one or more configuration values, control settings, and/or operational instructions that indicate how the UE 104 is to modify transmission characteristics for an uplink transmission, a resource allocation for the uplink transmission, power levels for the uplink transmission, beam selection for the uplink transmission, or other communication characteristics of the uplink transmission to reduce interference with other devices operating on shared spectrum resources. The NE 102 then receives an uplink transmission from the first UE after the first UE applies the parameters to the uplink transmission.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

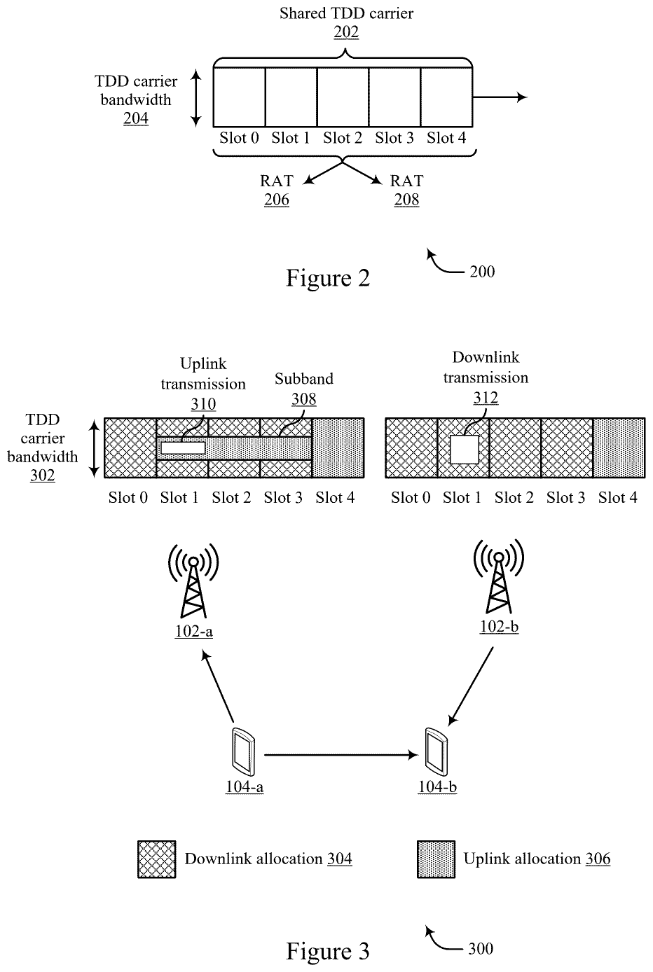

FIG. 2 illustrates an example of a resource diagram 200 in accordance with aspects of the present disclosure. In some examples, the resource diagram 200 implements or is implemented by aspects of the wireless communications system 100. For example, the resource diagram 200 may be implemented by one or more UEs and/or NEs, which may be an example of NEs 102 and UEs 104 as described with reference to FIG. 1. The resource diagram 200 illustrates an example of multi-RAT spectrum sharing on a TDD carrier, where UEs and/or NEs operating using different RATs may perform wireless communications concurrently on shared frequency resources.

The resource diagram 200 includes a shared TDD carrier 202 that spans multiple time slots and frequency resources. For example, the shared TDD carrier 202 may extend across multiple time slots, such as slot 0 through slot 4. A slot is a basic time unit in wireless communication that includes a defined numerical quantity of OFDM symbols, where a duration and symbol count of each slot may depend on a numerology and cyclic prefix configuration. The shared TDD carrier 202 may span a TDD carrier bandwidth 204, which represents a total frequency spectrum allocated for both uplink and downlink communications within the shared TDD carrier 202. The shared TDD carrier 202 may support communications for multiple RATs, such as a first RAT 206 and a second RAT 208, where each RAT may have different protocols, scheduling schemes, or duplexing modes within a same shared TDD carrier 202. In some examples, the shared TDD carrier 202 may span a different numerical quantity of time slots, such as fewer than five slots or more than five slots, depending on a frame structure, numerology, or configuration criterion. Additionally, or alternatively, the TDD carrier bandwidth 204 may vary in size, ranging from narrow bandwidth allocations (e.g., less than a threshold value) to wide bandwidth allocations (e.g., greater than a threshold value), based on spectrum availability, service criterion, or deployment scenarios.

One or more devices utilizing the first RAT 206 may operate using TDD scheduling on the shared TDD carrier 202, where uplink and downlink transmissions alternate in time across the TDD carrier bandwidth 204. In some cases, the first RAT 206 may be a 5G NR RAT that allocates time slots for uplink transmissions and other time slots for downlink transmissions. For example, during slot 0 and slot 2, a device (e.g., a UE and/or NE) utilizing the first RAT 206 may perform downlink communications on the frequency resources within the TDD carrier bandwidth 204, while during slot 1 and slot 3, the same frequency resources may be allocated for uplink communications. The first RAT 206 may utilize the full spectrum width of the TDD carrier bandwidth 204 during each allocated time slot, providing maximum spectral efficiency for single-RAT operation, but utilizing time-based coordination to avoid interference between uplink and downlink transmissions.

One or more devices utilizing the second RAT 208 may operate using SBFD operation on the same shared TDD carrier 202, where uplink and downlink transmissions occur simultaneously on different frequency subbands within the TDD carrier bandwidth 204. In some cases, the second RAT 208 may be a 6G system that divides (e.g., partitions, segments, splits) the TDD carrier bandwidth 204 into multiple frequency subbands. For example, during any time slot (e.g., slot 0 through slot 4), one or more subbands may be allocated for uplink transmissions, while other subbands may be simultaneously allocated for downlink transmissions, which is described in further detail with respect to FIG. 3. In some cases, the second RAT 208 may allocate a lower portion of the TDD carrier bandwidth 204 for uplink communications and an upper portion of the TDD carrier bandwidth 204 for downlink communications, or may implement complex subband allocation patterns that adapt (e.g., adjust, modify, configure) based on traffic demands, interference conditions, and/or service criterion. The SBFD operations may enable devices utilizing the second RAT 208 to achieve higher spectral efficiency and lower latency compared to TDD operation, but may introduce additional complexity in managing CLI between simultaneous uplink and downlink transmissions.

FIG. 3 illustrates an example of a resource diagram 300 in accordance with aspects of the present disclosure. In some examples, the resource diagram 300 implements or is implemented by aspects of the wireless communications system 100 and the resource diagram 200. For example, the resource diagram 300 may be implemented by a UE 104-a, a UE 104-b, an NE 102-a, and an NE 102-b, which may be an example of NEs 102 and UEs 104 as described with reference to FIG. 1. The resource diagram 300 may include a shared TDD carrier with a TDD carrier bandwidth 302, which may be an example of the shared TDD carrier 202 with the TDD carrier bandwidth 204, as described with reference to FIG. 2. The resource diagram 300 illustrates an example of multi-RAT spectrum sharing on a TDD carrier, where UEs and/or NEs operating using different RATs may perform wireless communications concurrently on shared frequency resources.

In some examples, an NE (e.g., the NE 102-a and/or the NE 102-b) may transmit signaling to one or more UEs (e.g., the UE 104-a and/or the UE 104-b) that indicates a resource allocation for transmission and/or reception of control information or data. The resource allocation can include a downlink allocation 304, which may include one or more time-frequency resources allocated for a downlink transmission, and/or an uplink allocation 306, which may include one or more time-frequency resources allocated for an uplink transmission. Uplink may refer to wireless communication from a UE to an NE, while downlink may refer to wireless communication from an NE to a UE. In some examples, the NE 102-a, the UE 104-a, the NE 102-b, and/or the UE 104-b may utilize a shared TDD carrier with a TDD carrier bandwidth 302 to perform one or more uplink and/or downlink transmissions. The TDD carrier bandwidth 302 is divided (e.g., partitioned, segmented, allocated) into distinct time and frequency regions for uplink and downlink communications based on the downlink allocation 304 and the uplink allocation 306. The downlink allocation 304 and the uplink allocation 306 may include any numerical quantity of time resources (e.g., slots), and may span any bandwidth (e.g., the TDD carrier bandwidth 302). The downlink allocation 304 and the uplink allocation 306 may be based on a mode of operation of the devices performing wireless communications utilizing the allocated resources.

For example, the NE 102-a may operate in an SBFD mode, where a downlink allocation 304 and an uplink allocation 306 may coexist (e.g., operate simultaneously, function concurrently, work together) within the same shared TDD carrier during a time interval (e.g., from slot 1 to slot 3). The NE 102-a may transmit scheduling information to the UE 104-a that allocates at least one subband 308 in a slot for an uplink transmission 310 in an uplink allocation 306, where one or more other subbands in the slot are included in a downlink allocation 304. The subband 308 may occupy (e.g., span, encompass, cover) a defined frequency range within the TDD carrier bandwidth 302, where the frequency boundaries of the subband 308 may be defined based on system criterion, traffic demands, or interference mitigation. In some cases, the subband 308 may be occupy a lower portion of the TDD carrier bandwidth 302, while a downlink allocation 304 may occupy the remaining upper portion of the frequency spectrum. Additionally, or alternatively, the subband 308 may be positioned in a middle or upper portion of the TDD carrier bandwidth 302, depending on an SBFD pattern configuration, among other factors.

The NE 102-a may determine an allocation for the subband 308 based on various factors, including current traffic load conditions, channel quality measurements, interference levels from neighboring cells or RATs, and quality of service (QoS) criterion for served UEs (e.g., the UE 104-a), among other factors. The NE 102-a may dynamically adjust (e.g., modify, reconfigure, adapt) a size and position of the subband 308 within the TDD carrier bandwidth 302 to improve wireless communications system performance and minimize interference with a second RAT operating on the same shared TDD carrier. The NE 102-a may include various parameters in an SBFD configuration to indicate the subband 308, such as bandwidth size of the subband 308, center frequency of the subband 308, guard band criterion of the subband 308, and/or power spectral density (PSD) criterion. The bandwidth size of the subband 308 may depend on uplink capacity criterion and frequency separation from the downlink allocation 304. Guard bands may be positioned between the subband 308 and the downlink allocation 304 to reduce (e.g., minimize, mitigate, limit) adjacent channel interference and ensure reliable communication quality for both uplink and downlink transmissions operating simultaneously within the same time interval.

In some cases, the NE 102-b may operate in a TDD mode without performing SBFD operation, such that the NE 102-b alternates between uplink and downlink transmissions across different time intervals using the entire TDD carrier bandwidth 302. For example, the NE 102-b may allocate the full spectrum of the TDD carrier bandwidth 302 for downlink transmissions during one or more time slots and subsequently switch to allocate the same frequency resources for uplink transmissions during other time slots. During a first time interval, the NE 102-b may utilize the entire TDD carrier bandwidth 302 for the downlink allocation 304 to transmit signals to the UE 104-b, while during a subsequent time interval, the NE 102-b may reconfigure (e.g., switch, change, modify) the same frequency resources to support uplink allocation 306 for receiving transmissions from the UE 104-b.

In some examples, the UE 104-a operates using a first RAT (e.g., 6G) and communicates with the NE 102-a through an SBFD configuration, while the UE 104-b operates using a second RAT (e.g., 5G NR) and communicates with the NE 102-b using TDD scheduling on the shared TDD carrier bandwidth 302. The UE 104-a may transmit an uplink transmission 310 to the NE 102-a within a subband 308 of the SBFD configuration, while the NE 102-b may simultaneously transmit a downlink transmission 312 to the UE 104-b on overlapping frequency resources within the shared TDD carrier bandwidth 302. The concurrent operation on overlapping frequency resources may create CLI, where the uplink transmission 310 from the UE 104-a interferes with the downlink reception at the UE 104-b, potentially degrading the signal quality and communication performance for the UE 104-b. The CLI may increase noise levels, reduce SINR, and decrease throughput for the affected communication link between the NE 102-b and the UE 104-b.

Although reference is made herein to uplink transmissions from a UE 104-a to an NE 102-a, the described techniques may also be applicable to downlink transmissions from an NE 102-a to a UE 104-a and/or to sidelink transmissions from a UE 104-a to a UE 104-b. In some cases, the UE 104-a may receive a downlink transmission from the NE 102-a, while the UE 104-b may transmit an uplink transmission to the NE 102-b, creating interference where the downlink reception at the UE 104-a is affected by the uplink transmission from the UE 104-b. Additionally, or alternatively, the NE 102-a and the NE 102-b may represent a same NE (e.g., transmission and reception point (TRP) or base station) supporting both RATs simultaneously, where the single NE manages communications for both the UE 104-a using the first RAT and the UE 104-b using the second RAT, potentially creating NE-to-NE interference within the same device between transmit and receive chains. In some other examples, the UE 104-a and the UE 104-b may engage in sidelink communications directly with each other while operating on the shared TDD carrier bandwidth 302, where the SBFD operation of the UE 104-a may interfere with the TDD operation of the UE 104-b, or vice versa, resulting in coordination mechanisms to manage interference in device-to-device communication scenarios.

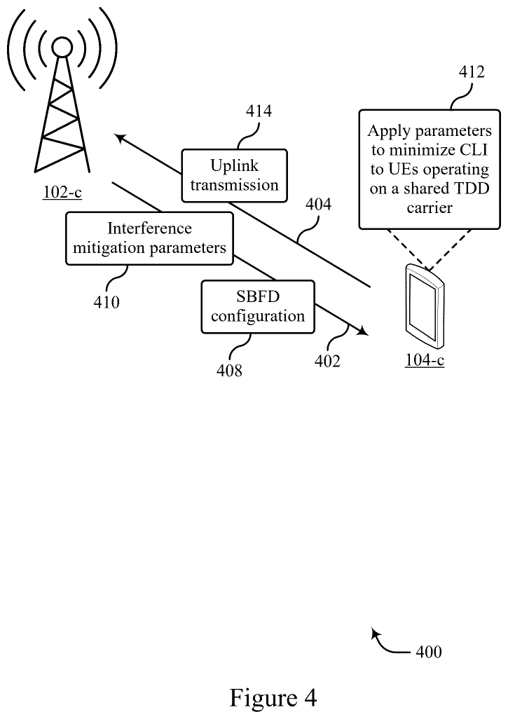

FIG. 4 illustrates an example of a wireless communications system 400 in accordance with aspects of the present disclosure. In some examples, the wireless communications system 400 implements or is implemented by aspects of the wireless communications system 100, the resource diagram 200, and the resource diagram 300. For example, the wireless communications system 400 may include an NE 102-c and a UE 104-c, which may be examples of the NE 102-a and the UE 104-a as described with reference to FIG. 2. In some examples, the NE 102-c may transmit signaling (e.g., control signaling and/or data) to the UE 104-c via a downlink wireless communications link 402. Additionally, or alternatively, the UE 104-c may transmit signaling (e.g., control signaling and/or data) to the NE 102-c via an uplink wireless communications link 404. For example, the NE 102-c may configure the UE 104-c with various information to minimize interference between the UE 104-c and another UE operating using a different RAT on a shared TDD carrier.

In some cases, the NE 102-c may operate in an SBFD mode, and the UE 104-c may be scheduled with an uplink transmission on a shared TDD carrier, as described with reference to FIGS. 1 through 3. In the wireless communications system 400, the UE 104-c may operate using a first RAT (e.g., 6G) and may be configured to communicate with the NE 102-c on the shared TDD carrier that also supports devices using a TDD mode and a second RAT (e.g., 5G NR). The NE 102-c (e.g., the 6G RAT) may semi-statically, periodically, aperiodically, or dynamically schedule uplink communication (e.g., a signal, transmission, channel, reference signal, including a physical uplink shared channel (PUSCH), a physical uplink control channel (PUCCH), a physical random access channel (PRACH), or a sounding reference signal (SRS)) from one or more UEs (e.g., the UE 104-c) in one or more symbols within a slot (e.g., within slot 1). An NE utilizing an 5G NR RAT may schedule (e.g., configure) a common downlink signal and/or channel, such as a synchronization signal block (SSB), a control resource set #0 (CORESET #0), a common search space, or a system information block 1 (SIB1) for a UE or a group of UEs. In the multi-RAT spectrum sharing scenario, the UE 104-c may transmit uplink signals within an uplink subband of the SBFD configuration, while another UE operating using the second RAT may simultaneously receive downlink signals on overlapping frequency resources of the shared TDD carrier, potentially creating interference that degrades communication performance, as described with reference to FIG. 3. The 5G-NR UEs may suffer from strong inter-RAT inter-UE CLI, negatively impacting reception and/or decoding performance.

In some examples, the NE 102-c may transmit an SBFD configuration 408 to the UE 104-c via the downlink wireless communications link 402 to establish (e.g., configure, set up, define) the operational parameters for SBFD operation within the shared TDD carrier. The SBFD configuration 408 may include various parameters, such as uplink subband allocations indicating which frequency subbands are reserved for uplink transmissions, downlink subband allocations indicating frequency subbands reserved for downlink communications, subband bandwidth specifications defining the width of each allocated subband, time-domain patterns indicating when SBFD operation is active or inactive, guard band configurations to minimize or reduce adjacent subband interference, and/or power control parameters for managing transmission power levels within each subband. That is, an SBFD configuration includes a set of parameters and settings that define how SBFD operation is implemented within a wireless communication system, including the allocation of frequency subbands for simultaneous uplink and downlink transmissions, timing patterns, power control settings, and other operational characteristics that enable concurrent bidirectional communication on different frequency resources within the same time interval. The SBFD configuration 408 may be conveyed (e.g., transmitted, communicated, delivered) through various signaling mechanisms, including RRC signaling for semi-static configuration updates that remain relatively stable over greater than a threshold duration, MAC-CE signaling for more dynamic adjustments that may change on a per-slot or per-frame basis, DCI for dynamic (e.g., real-time) scheduling and resource allocation updates, or periodic broadcast signaling (e.g., SIBs for network-wide SBFD configuration updates). Additionally, or alternatively, the NE 102-c may coordinate with other neighboring or nearby NEs (e.g., NEs within a threshold distance from the NE 102-c), such as a 5G NR base station serving nearby UEs. The NE 102-c may coordinate with the other NEs through interfaces, including X2 or Xn connections, to exchange (e.g., share, communicate, transmit) scheduling information, interference measurements, and resource allocation. The coordination may enable the NE 102-c to obtain (e.g., receive, acquire, collect) information of downlink transmission schedules for 5G NR UEs operating on the shared TDD carrier (e.g., including frequency-domain resource element (RE), RB, RB group (RBG) level information, and/or time-domain symbol, slot, or frame level information, and a corresponding periodicity time or level), providing for the NE 102-c to determine or select the SBFD configuration 408 and associated interference mitigation parameters to minimize interference between the UE 104-c and other UEs operating under different RATs within the same geographic area.

In some examples, the NE 102-c may transmit interference mitigation parameters 410 to the UE 104-c via the downlink wireless communications link 402 to provide interference mitigation instructions that reduce interference (e.g., CLI) between the UE 104-c and other UEs operating under different RATs on the shared TDD carrier. The NE 102-c may transmit the interference mitigation parameters 410 via control signaling, such as RRC signaling for semi-persistent parameter updates that may remain valid for multiple frames or subframes, MAC-CE signaling for medium-term adjustments that adapt to changing interference conditions on a slot-by-slot or frame-by-frame basis, unicast and/or group common DCI signaling scrambled with a dedicated radio network temporary identifier (RNTI) for dynamic parameter updates that respond to interference scenarios within individual scheduling intervals, or broadcast signaling through SIBs for network-wide interference mitigation policies that apply to UEs within a coverage area of the NE 102-c. The transmission frequency of the interference mitigation parameters 410 may vary according to network conditions, interference levels, and/or system criterion, ranging from periodic updates to semi-static configurations when interference patterns are relatively stable. The NE 102-c may be triggered to transmit the interference mitigation parameters 410 based on various conditions, including detection of increased interference levels above a predetermined threshold, reception of scheduling information from neighboring NEs indicating potential resource conflicts, changes in traffic patterns or UE mobility that affect interference scenarios, and/or periodic interference measurement reports from served UEs and/or neighboring NEs. The interference mitigation parameters 410 may include, but are not limited to, uplink resource muting patterns that specify time and frequency resources where the UE 104-c is to avoid transmitting to prevent interference with downlink receptions at other UEs, power control adjustments including power offset values or maximum transmit power limits to reduce interference levels, time and frequency domain offsets that shift transmission resources away from conflicting allocations, beam switching indicators that direct the UE 104-c to use alternative transmission beams or antenna panels to spatially separate interfering signals, priority-based transmission dropping rules that indicate when the UE 104-c is to skip one or more transmissions based on interference, and/or dynamic SBFD pattern updates that modify subband allocations to minimize resource overlap with other RATs operating on the shared TDD carrier.

At 412, the UE 104-c may apply the interference mitigation parameters 410 received from the NE 102-c to reduce interference with other UEs operating on the shared TDD carrier. The UE 104-c may implement various interference mitigation techniques based on the parameters received, where each parameter type may address different aspects of interference reduction through resource coordination, power management, spatial separation, or transmission scheduling adjustments. In some examples, the UE 104-c may implement multiple interference mitigation techniques, such that different parameters can be combined to minimize the interference at neighboring UEs.

In some examples, when the interference mitigation parameters 410 include uplink resource muting patterns, the UE 104-c may mute (e.g., avoid, skip, refrain from) one or more uplink transmissions (e.g., the uplink transmission 414) on specific time and frequency resources that overlap with downlink receptions at other UEs operating under different RATs. Each uplink resource muting pattern includes one or more bitmaps (e.g., a bitmap for indicating RE level resources, a bitmap for indicating RB level resources, a bitmap for indicating symbol level resources, a bitmap for indicating slot level resources). Additionally, or alternatively, the interference mitigation parameters 410 includes a frequency shift (e.g., RE and/or RB level), a time-shift or starting symbol or slot, a time periodicity, and/or a periodicity level (periodic, aperiodic, etc.) for applying the uplink resource muting patterns. Additionally, or alternatively, the interference mitigation parameters 410 includes an uplink BWP index, an SBFD pattern index, and/or a panel or beam index for applying the uplink resource muting patterns. A BWP is a contiguous set of physical RBs (PRBs) within a carrier bandwidth that defines a subset of the total available spectrum for a UE to use for uplink or downlink communications.

If the muting pattern indicates that one or more RBs in a slot are allocated for 5G NR downlink transmissions to a nearby UE, then the UE 104-c may avoid transmitting on the resources during the indicated time interval, thereby preventing interference with the 5G NR downlink reception. The UE 104-c may apply the muting pattern utilizing a bitmap that indicates which REs are to be muted, applying frequency domain offsets to shift the muting pattern to one or more frequency locations, and/or by using time domain offsets to align the muting pattern with target temporal resources. In some examples, the UE 104-c may adjust an uplink transmit power, modulation and coding scheme (MCS), transport block size (TBS), and/or a coding rate of symbols mapped on the unmuted uplink resources (e.g., by using a configured formula in function of used or unmuted REs) and/or by a fixed or configured value. The UE 104-c may implement a rate matching pattern on uplink resources around 5G NR common downlink signal or channel resources that are periodically transmitted or using an on demand framework. The NE 102-c may configure multiple uplink muting patterns, and the NE 102-c may indicate a muting pattern index corresponding to at least one of the multiple uplink muting patterns for the UE 104-c to use for rate matching around a corresponding downlink common channel or signal.

In some cases, when the interference mitigation parameters 410 include time or frequency domain offsets, the UE 104-c may shift (e.g., adjust, modify, relocate) uplink transmission resources away from conflicting allocations. The configuration message may indicate one or more time and/or frequency shift (e.g., offset) values for an uplink transmission 414, which may include a scheduled uplink signal or channel occasion and/or repetition. The NE 102-c determines (e.g., identifies, selects) the shift values to avoid colliding with a scheduled downlink signal or channel of a 5G NR RAT.

In some cases, when the interference mitigation parameters 410 include power control adjustments, the UE 104-c may reduce (e.g., decrease, lower) a transmit power to minimize interference levels. The configuration message may indicate to the UE 104-c an uplink transmit power offset and/or an uplink transmit power maximum value associated with one or more of indicated occasions or repetitions of the uplink transmission 414. In the uplink maximum transmit power calculation, a scaling factor can be added to the P_{cmax}, or a new uplink maximum power value considering the interference is provided. The UE 104-c may use a minimum of P_{cmax} and the newly provided maximum value to determine the uplink transmit power. For example, if the parameters specify a power offset of −6 decibels (dB), then the UE 104-c may reduce a transmit power by 6 dB from an original power level. Additionally, or alternatively, if a maximum transmit power limit of +20 dB-milliwatts (dBm) is indicated, then the UE 104-c may cap a transmission power at the indicated level regardless of other power control algorithms.

In some examples, when the interference mitigation parameters 410 include beam switching or panel switching indicators, including a beam index, TCI state, and/or a panel switch indicator, the UE 104-c may change (e.g., switch, modify, adjust) a transmission beam direction or antenna panel selection to spatially separate interfering signals. For example, the NE 102-c may configure the UE 104-c to switch an uplink transmit beam and/or panel for the uplink transmission 414 occasion or repetition. A beam index refers to a numerical identifier that indicates a transmission or reception beam configuration from a set of available beam patterns, where each beam index corresponds to defined antenna array settings, phase adjustments, and directional characteristics that determine the spatial direction and coverage pattern of wireless signal transmission or reception. A TCI state refers to a parameter that indicates the configuration of transmission and reception beams, antenna ports, or spatial filtering settings for wireless communication, providing information about how signals are to be transmitted or received in terms of spatial characteristics, beam directions, and antenna configurations. A panel switch indicator refers to a control parameter that instructs a UE to change from one antenna panel or antenna array to another antenna panel within a multi-panel antenna system, enabling the UE to select different spatial transmission or reception characteristics for improved communication performance or interference mitigation.

In some cases, when the interference mitigation parameters 410 include transmission dropping indicators, the UE 104-c may skip (e.g., drop, omit, cancel, terminate) one or more uplink transmissions or repetitions that cause greater than a threshold level of interference. The configuration message may indicate to the UE 104-c to drop or skip the uplink transmission 414 occasion or repetition. In some examples, the NE 102-c may configure uplink symbols overlapping with one or more 5G NR common downlink channel or signal as invalid symbols, and the UE 104-c may drop the uplink symbols. In some cases, the NE 102-c and/or the UE 104-c may assign one or more priority values to uplink channels or signals when compared with one or more downlink common channel or signals. Additionally, or alternatively, the NE 102-c may indicate a reference priority value to the UE 104-c. In some examples, a smaller priority value means higher priority while a higher priority value means lower priority. For example, if a priority value of a 6G channel or signal is larger than the reference value, then the UE 104-c may drop the uplink channel or signal. If the priority value of the 6G channel or signal is smaller than the reference priority value, then the UE 104-c transmits (e.g., does not drop) the uplink channel or signal. The NE 102-c may semi-statically signal the reference value.

For example, if the parameters indicate that the uplink transmission 414 overlaps with a high-priority 5G NR downlink transmission, then the UE 104-c may compare priority values and drop the uplink transmission 414 if the interfering transmission has a higher priority. The UE 104-c may also drop one or more repetitions of a transmission, while maintaining other repetitions that do not cause interference. For example, a 6G RAT PRACH signal may have a higher priority compared to a 5G NR downlink SIB, CORESET #0, or common search spaces, or vice-versa. In some other examples, a 6G RAT PUSCH may have lower priority value compared to 5G NR channels or signals. In some cases, if the uplink transmission 414 is associated with a repetition counter, then the UE 104-c may skip increasing the counter for a dropped repetition occasion. In some other examples, the UE 104-c may increase the counter even for a dropped repetition occasion. The configuration message may indicate to the UE 104-c an indication to override a configured collision handling rule that may prioritize the uplink transmission 414 occasion or repetition over a scheduled downlink signal or channel occasion or repetition. Such collision handling may further depend on the configured priority value and/or reference value. In some examples, the collision handling procedure may be defined for each 6G uplink channel against each of the downlink common channel or signals.

The UE 104-c may be configured (e.g., scheduled, instructed, operated) to apply multiple parameters simultaneously to achieve enhanced interference mitigation through combined techniques. For example, the UE 104-c may be configured to apply both resource muting and power control by muting transmissions on one or more RBs, while reducing power on remaining transmission resources, providing both spatial and power-based interference reduction. In some other examples, the UE 104-c may be configured to combine beam switching with frequency domain offsets by selecting a different transmission beam and shifting to a different frequency band, achieving both spatial and spectral separation from interfering signals. Additionally, or alternatively, the UE 104-c may be configured to implement a combination of time domain offsets and transmission dropping, where the UE 104-c first attempts to avoid interference by shifting transmission timing, and if conflicts remain, then the UE 104-c may drop one or more transmissions that cannot be adequately separated through timing adjustments. In some cases, the UE 104-c may be configured to apply resource muting patterns together with dynamic SBFD pattern updates, where the UE 104-c mutes one or more resources within an updated subband configuration that has been modified to minimize overlap with other RATs operating on the shared TDD carrier.

The NE 102-c may indicate to the UE 104-c to revert or reconfigure a configured uplink RB and/or an SBFD symbol or slot belonging to the configured uplink subband to a downlink or flexible RB and/or to a non-SBFD downlink or flexible symbol or slot (e.g., using one or more bitmaps, including a first bitmap reverting or reconfiguring uplink RBs to downlink or flexible RBs, a second bitmap reverting or reconfiguring SBFD symbols within an indicated slot to non-SBFD downlink or flexible symbols, and/or a third bitmap indicating a slot where the second bitmap is applied). In some examples, the second bitmap is not indicated, where the UE 104-c assumes each of the SBFD symbols within a slot indicated in the third bitmap are reverted or reconfigured to non-SBFD downlink or flexible symbols. The NE 102-c may also indicate to the UE 104-c to switch to or activate a different SBFD pattern (e.g., or a different uplink BWP) from a set of configured SBFD patterns (e.g., or a set of configured uplink BWPs).

In some examples, the UE 104-c may transmit the uplink transmission 414 to the NE 102-c via the uplink wireless communications link 404 after applying the interference mitigation parameters and utilizing the SBFD configuration received from the NE 102-c. The UE 104-c may select (e.g., determine, identify, choose) one or more uplink subbands within the SBFD configuration that have been designated for uplink transmissions, where the subbands may represent defined frequency ranges within the shared TDD carrier bandwidth that are allocated for simultaneous uplink communication, while other subbands carry downlink transmissions. The UE 104-c may map (e.g., assign, allocate, distribute) the uplink transmission data to time and frequency resources within the selected uplink subbands, taking into account any resource muting patterns that may exclude one or more RBs or REs from transmission to reduce or avoid interference with 5G NR downlink receptions. Additionally, or alternatively, the UE 104-c may adjust (e.g., modify, configure, set) the transmission power level for the uplink transmission 414 based on any power control parameters received, such as applying power offset values to reduce the transmission power by a specified amount or limiting the maximum transmission power to a predetermined threshold to minimize interference. Additionally, or alternatively, the UE 104-c may configure (e.g., select, activate, switch) a transmission beam or antenna panel based on beam switching indicators or panel switch indicators received in the interference mitigation parameters 410, directing the energy of the uplink transmission 414 toward the NE 102-c, while spatially isolating the signal from other UEs operating under different RATs. The UE 104-c may also apply any time or frequency domain offsets by shifting the transmission timing or frequency allocation of the uplink transmission 414 away from conflicting resource allocations, ensuring that the uplink transmission 414 occurs on resources that minimize overlap with downlink transmissions associated with the second RAT.

The techniques described herein may be applicable to various other communication scenarios, including downlink transmissions from the NE 102-c to the UE 104-c that interfere with uplink receptions at another NE, sidelink communications between UEs operating under different RATs, interference mitigation in scenarios where a single NE supports multiple RATs simultaneously, and coordination mechanisms for device-to-device communications in multi-RAT environments.

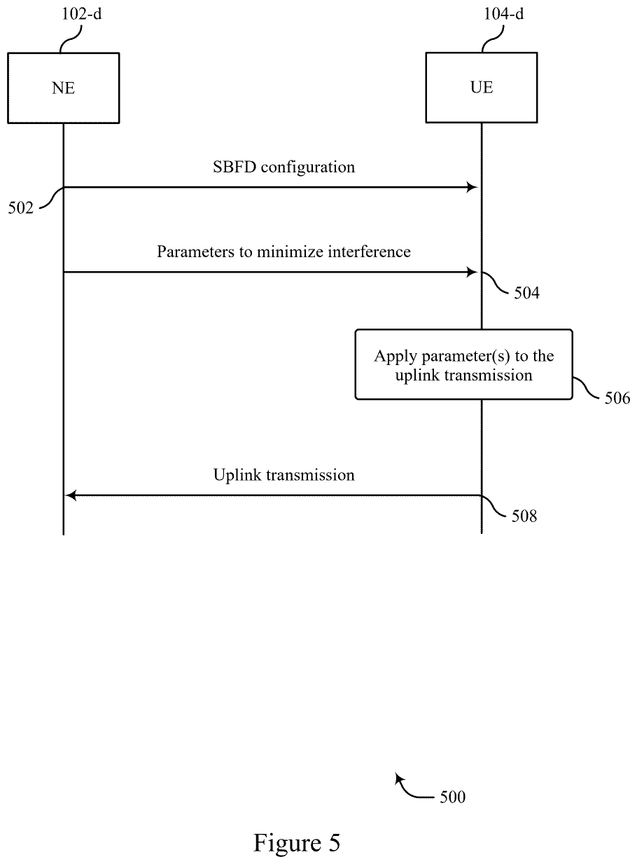

FIG. 5 illustrates an example of a signaling diagram 500 in accordance with aspects of the present disclosure. In some examples, the signaling diagram 500 implements or is implemented by aspects of the wireless communications system 100, the resource diagram 200, the resource diagram 300, and the wireless communications system 400. The signaling diagram 500 may implement or be implemented by one or more devices, such as an NE 102-d and a UE 104-d, which may be examples of an NE 102-c and a UE 104-c as described with reference to FIG. 4. The signaling diagram 500 may illustrate an example of interference mitigation for SBFD operation with multiple RATs in wireless communications. Alternative examples of the following may be implemented, where some processes are performed in a different order than described or are not performed. In some cases, processes may include additional features not mentioned below, or further processes may be added.

At 502, the NE 102-d transmits first signaling to the UE 104-d that indicates an SBFD configuration indicating at least one uplink subband and at least one downlink subband for a first RAT. In some cases, the SBFD configuration operates on a shared TDD carrier that supports the first RAT and a second RAT different from the first RAT (e.g., a 5G NR RAT and a 6G RAT, among other examples). The NE 102-d may transmit the first signaling via RRC signaling, MAC-CE signaling, or other control signaling mechanisms to establish the operational parameters for SBFD operation. The SBFD configuration may include uplink subband allocations, downlink subband allocations, subband bandwidth specifications, time-domain patterns, guard band configurations, and/or power control parameters that define how the UE 104-d is to operate within the shared spectrum. In some examples, the shared TDD carrier may be configured between a 6G RAT and a 5G NR RAT, where the NE 102-d employs SBFD mode and a 5G NR NE employs a TDD mode. The NE 102-d may partition frequency domain resources of one or more downlink and/or flexible symbols into multiple subbands, where the NE 102-d allocates at most one of the subbands as uplink for uplink communications. The NE 102-d may also indicate a set of SBFD patterns from which the UE 104-d can select or switch between when interference conditions change.

At 504, the NE 102-d transmits second signaling to the UE 104-d that indicates one or more parameters to minimize an interference between the UE 104-d and a second UE when operating on the shared TDD carrier. The UE 104-d operates using the first RAT and the second UE operates using the second RAT. A downlink configuration for a second UE overlaps at least in part with the SBFD configuration on the shared TDD carrier. The NE 102-d may include various interference mitigation parameters in the second signaling, such as uplink resource muting patterns that specify time and frequency resources where the UE 104-d is to avoid transmitting (e.g., during one or more time and frequency resources that the NE 102-d allocates for a downlink transmission to the second UE), time and frequency domain offsets to shift transmission resources away from conflicting allocations, power control adjustments (e.g., including power offset values or maximum transmit power limits), beam switching indicators or panel switch indicators for spatial separation of interfering signals, priority-based transmission dropping rules, and/or dynamic SBFD pattern updates. The NE 102-d may configure the uplink resource muting patterns to include one or more bitmaps (e.g., one bitmap for indicating RE-level resources, one bitmap for indicating RB-level resources, one bitmap for indicating symbol-level resources, one bitmap for indicating slot-level resources), an offset (e.g., shift) in a frequency domain to apply the at least one uplink resource muting pattern, an offset in a time domain to apply the at least one uplink resource muting pattern, a starting resource in the time domain to apply the at least one uplink resource muting pattern, a periodicity to apply the at least one uplink resource muting pattern, a periodicity level to apply the at least one uplink resource muting pattern (e.g., periodic, aperiodic), an uplink BWP index to apply the at least one uplink resource muting pattern, an SBFD pattern index to apply the at least one uplink resource muting pattern, a panel index to apply the at least one uplink resource muting pattern, or a beam index to apply the at least one uplink resource muting pattern.

The NE 102-d may configure the one or more parameters to include an offset in at least one of a time domain or a frequency domain that avoids a downlink transmission to the second UE. Additionally, or alternatively, the NE 102-d may configure the one or more parameters to include an indication to drop at least one of the uplink transmission or a repetition of the uplink transmission when the uplink transmission or the repetition of the uplink transmission overlaps with a downlink transmission to the second UE. Additionally, or alternatively, the NE 102-d may configure the one or more parameters to include at least one of a power offset value or a maximum transmit power limit. Additionally, or alternatively, the NE 102-d may configure the one or more parameters to include at least one of a beam index, a TCI state indicator, or a panel switch indicator. Additionally, or alternatively, the NE 102-d may configure the one or more parameters to indicate an update to at least one of an uplink subband time or a frequency dimension for the uplink transmission.

In some examples, the NE 102-d may configure the UE 104-d (e.g., via third signaling prior to the signaling at 504) with a set of uplink resource muting patterns including the at least one uplink resource muting pattern. The NE 102-d configures the one or more parameters to include an index that identifies the at least one uplink resource muting pattern that the UE 104-d uses for rate matching around downlink common channels or signals, such as SSB, CORESET #0, common search space, or SIB1. The NE 102-d can activate or indicate an uplink resource muting pattern index in the set of uplink resource muting patterns for the UE 104-d to use. In some cases, the NE 102-d may receive scheduling information from an additional NE operating the second RAT. The scheduling information may be for a downlink transmission to the second UE. The NE 102-d may select at least one uplink resource muting pattern that minimizes an overlap between one or more first time and frequency resources for the uplink transmission and one or more second time and frequency resources for the downlink transmission.

For power control adjustments, the UE 104-d may add a scaling factor to the P_{cmax}, or the NE 102-d may provide a new uplink maximum power value considering the interference. The UE 104-d may use minimum of P_{cmax} and the newly provided maximum value to determine the uplink transmit power. In some cases, the NE 102-d and/or the UE 104-d may assign priority values to one or more uplink channels or signals when compared with one or more downlink common channels or signals. Additionally, or alternatively, the NE 102-d may configure (e.g., semi-statically) a reference priority value that considers the downlink transmission to the second UE. If the UE 104-d determines that a priority value of a 6G channel or signal is larger than the reference value, then the UE 104-d may drop the uplink channel or signal. In some cases, the NE 102-d may transmit third signaling prior to the second signaling that indicates a set of SBFD patterns. The NE 102-d configures the one or more parameters to include an indication of an SBFD pattern of the set of SBFD patterns (e.g., an SBFD pattern that includes one or more first time and frequency resources for the uplink transmission). The NE 102-d selects the SBFD pattern to minimize an overlap between the one or more first time and frequency resources and one or more second time and frequency resources for a downlink transmission to the second UE. Additionally, or alternatively, the NE 102-d may transmit third signaling prior to the second signaling that indicates a set of uplink BWPs. The NE 102-d configures the one or more parameters to indicate an uplink BWP of the set of uplink BWPs for the uplink transmission. The NE 102-d selects the uplink BWP to minimize an overlap between one or more first time and frequency resources for the uplink transmission and one or more second time and frequency resources for a downlink transmission to the second UE.

The NE 102-d may transmit the parameters in control signaling, such as RRC signaling, MAC-CE signaling, DCI signaling, and/or broadcast signaling. In some cases, the NE 102-d may transmit the SBFD configuration and the parameters to minimize the interference in the same signaling. In some other cases, the NE 102-d may transmit the SBFD configuration and the parameters to minimize the interference in different signaling.

At 506, the UE 104-d applies one or more of the interference mitigation parameters that the UE 104-d received from the NE 102-d. If the NE 102-d includes uplink resource muting patterns in the parameters, then the UE 104-d may mute the uplink transmission on one or more time and frequency resources that overlap with downlink receptions at other UEs operating under different RATs. If the NE 102-d includes time or frequency domain offsets in the parameters, then the UE 104-d may apply the offset to one or more time or frequency resources for the uplink transmission to avoid colliding with scheduled or configured downlink signals or channels of the second RAT. If the NE 102-d includes power control adjustments in the parameters, then the UE 104-d may apply at least one of the power offset value or the maximum transmit power limit to a transmit power for the uplink transmission to minimize interference levels. If the NE 102-d includes beam switching or panel switching indicators in the parameters, then the UE 104-d may switch at least one of a first panel to a second panel that the panel switch indicator indicates or a first uplink transmit beam to a second uplink transmit beam that at least one of the beam index or the TCI state indicator indicates to spatially separate interfering signals. The UE 104-d may determine that panel switching depends on the type of uplink channel.

If the NE 102-d includes transmission dropping indicators in the parameters, then the UE 104-d may drop at least one of the uplink transmission or the repetition of the uplink transmission that may cause greater than a threshold interference, where the UE 104-d may determine a priority value for at least one of the uplink transmission or the repetition of the uplink transmission is greater than the reference priority value (e.g., where the NE 102-d may configure uplink symbols overlapping with one or more 5G NR common downlink channels or signals as invalid symbols). The UE 104-d may also revert, using the update, one or more of an uplink resource block to a downlink resource block for a downlink transmission to the second UE or an SBFD time resource to a non-SBFD time resource by adjusting uplink subband time and/or frequency dimensions. Additionally, or alternatively, the UE 104-d may switch to or activate a different SBFD pattern from a set of configured SBFD patterns. Additionally, or alternatively, the UE 104-d may switch to or activate an uplink BWP from a set of configured uplink BWPs to avoid colliding resources.

At 508, the UE 104-d transmits an uplink transmission to the NE 102-d using the one or more parameters with the applied interference mitigation parameters and utilizing the SBFD configuration. The UE 104-d may select one or more uplink subbands within the SBFD configuration that the NE 102-d has designated for uplink transmissions and the UE 104-d may map the uplink transmission data to one or more time and frequency resources within the selected uplink subbands. The uplink transmission may include various types of uplink signals and channels, such as PUSCH, PUCCH, PRACH, or SRS that the NE 102-d semi-statically, periodically, dynamically, or aperiodically schedules. The UE 104-d mutes the uplink transmission on the one or more second time and frequency resources when the UE 104-d applies uplink resource muting patterns. In some cases, the UE 104-d transmits the uplink transmission in the at least one uplink subband of the SBFD configuration.

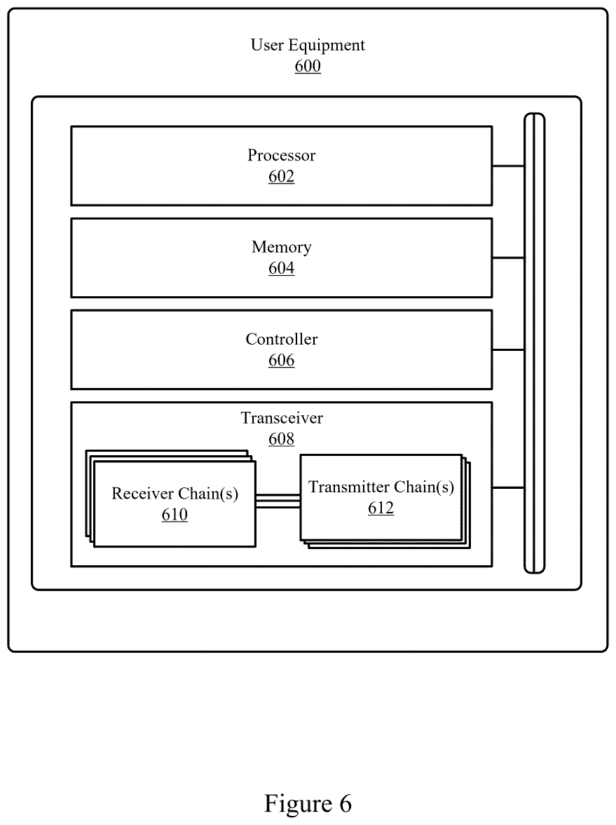

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a central processing unit (CPU), an ASIC, a field-programmable gate-array (FPGA), or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving first signaling that indicates an SBFD configuration indicating at least one uplink subband and at least one downlink subband associated with a first RAT, where the SBFD configuration operates on a shared TDD carrier associated with the first RAT and a second RAT different from the first RAT, receiving second signaling that indicates one or more parameters to minimize an interference between the UE 600 and a second UE when operating on the shared TDD carrier, where the UE 600 is associated with the first RAT, and where the second UE is associated with the second RAT, and transmitting, to an NE associated with the first RAT, an uplink transmission based on the one or more parameters.

Additionally, the UE 600 may be configured to or operable to support any one or combination of the one or more parameters include an indication of at least one uplink resource muting pattern based on one or more time and frequency resources corresponding to a downlink transmission associated with the second UE, and to transmit the uplink transmission, muting the uplink transmission on the one or more time and frequency resources. Additionally, or alternatively, the UE 600 may be configured to or operable to support receiving, prior to the second signaling, third signaling that indicates a set of uplink resource muting patterns including the at least one uplink resource muting pattern, and where the one or more parameters include an index corresponding to the at least one uplink resource muting pattern. Additionally, or alternatively, the UE 600 may be configured to or operable to support the at least one uplink resource muting pattern includes one or more bitmaps, an offset in a frequency domain to apply the at least one uplink resource muting pattern, an offset in a time domain to apply the at least one uplink resource muting pattern, a starting resource in the time domain to apply the at least one uplink resource muting pattern, a periodicity to apply the at least one uplink resource muting pattern, a periodicity level to apply the at least one uplink resource muting pattern, an uplink BWP index to apply the at least one uplink resource muting pattern, an SBFD pattern index to apply the at least one uplink resource muting pattern, a panel index to apply the at least one uplink resource muting pattern, or a beam index to apply the at least one uplink resource muting pattern.

Additionally, or alternatively, the UE 600 may be configured to or operable to support the one or more parameters include an offset in at least one of a time domain or a frequency domain based on a downlink transmission associated with the second UE, and to transmit the uplink transmission, applying the offset to one or more time or frequency resources associated with the uplink transmission. Additionally, or alternatively, the UE 600 may be configured to or operable to support the one or more parameters include an indication to drop at least one of the uplink transmission or a repetition of the uplink transmission based on the uplink transmission or the repetition of the uplink transmission overlapping with a downlink transmission associated with the second UE, and to transmit the uplink transmission, dropping at least one of the uplink transmission or the repetition of the uplink transmission. Additionally, or alternatively, the UE 600 may be configured to or operable to support the one or more parameters include a reference priority value that is based on the downlink transmission associated with the second UE, and to drop at least one of the uplink transmission or the repetition of the uplink transmission, determining a priority value associated with at least one of the uplink transmission or the repetition of the uplink transmission is greater than the reference priority value.

Additionally, or alternatively, the UE 600 may be configured to or operable to support the one or more parameters include at least one of a power offset value or a maximum transmit power limit, and to transmit the uplink transmission, applying at least one of the power offset value or the maximum transmit power limit to a transmit power associated with the uplink transmission. Additionally, or alternatively, the UE 600 may be configured to or operable to support the one or more parameters include at least one of a beam index, a TCI state indicator, or a panel switch indicator, and to transmit the uplink transmission, switching at least one of a first panel to a second panel associated with the panel switch indicator or a first uplink transmit beam to a second uplink transmit beam associated with at least one of the beam index or the TCI state indicator. Additionally, or alternatively, the UE 600 may be configured to or operable to support the one or more parameters indicate an update to at least one of an uplink subband time or a frequency dimension associated with the uplink transmission, and to transmit the uplink transmission, reverting, based on the update, one or more of an uplink RB to a downlink RB corresponding to a downlink transmission associated with the second UE or an SBFD time resource to a non-SBFD time resource.

Additionally, or alternatively, the UE 600 may be configured to or operable to support receiving, prior to the second signaling, third signaling that indicates a set of SBFD patterns, where the one or more parameters include an indication of an SBFD pattern of the set of SBFD patterns that includes one or more first time and frequency resources corresponding to the uplink transmission, and where the SBFD pattern is based on minimizing an overlap between the one or more first time and frequency resources and one or more second time and frequency resources corresponding to a downlink transmission associated with the second UE. Additionally, or alternatively, the UE 600 may be configured to or operable to support receiving, prior to the second signaling, third signaling that indicates a set of uplink BWPs, where the one or more parameters indicate an uplink BWP of the set of uplink BWPs associated with the uplink transmission, and where the uplink BWP is based on minimizing an overlap between one or more first time and frequency resources corresponding to the uplink transmission and one or more second time and frequency resources corresponding to a downlink transmission associated with the second UE. Additionally, or alternatively, the UE 600 may be configured to or operable to support the uplink transmission is transmitted in the at least one uplink subband of the SBFD configuration, where a downlink configuration associated with the second UE overlaps at least in part with the SBFD configuration on the shared TDD carrier, and where the first RAT includes a 6G RAT and the second RAT includes 5G RAT.

Additionally, or alternatively, the UE 600 may support at least one memory (e.g., the memory 604) and at least one processor (e.g., the processor 602) coupled with the at least one memory and configured to or operable to cause the UE 600 to receive first signaling that indicates an SBFD configuration indicating at least one uplink subband and at least one downlink subband associated with a first RAT, where the SBFD configuration operates on a shared TDD carrier associated with the first RAT and a second RAT different from the first RAT, receive second signaling that indicates one or more parameters to minimize an interference between the UE 600 and a second UE when operating on the shared TDD carrier, where the UE 600 is associated with the first RAT, and where the second UE is associated with the second RAT, and transmit, to an NE associated with the first RAT, an uplink transmission based on the one or more parameters.

Additionally, the UE 600 may be configured to or operable to support any one or combination of the one or more parameters include an indication of at least one uplink resource muting pattern based on one or more time and frequency resources corresponding to a downlink transmission associated with the second UE, and to transmit the uplink transmission, the UE 600 may be configured to or operable to support to mute the uplink transmission on the one or more time and frequency resources. Additionally, or alternatively, the UE 600 may be configured to or operable to support to receive, prior to the second signaling, third signaling that indicates a set of uplink resource muting patterns including the at least one uplink resource muting pattern, and where the one or more parameters include an index corresponding to the at least one uplink resource muting pattern. Additionally, or alternatively, the UE 600 may be configured to or operable to support the at least one uplink resource muting pattern includes one or more bitmaps, an offset in a frequency domain to apply the at least one uplink resource muting pattern, an offset in a time domain to apply the at least one uplink resource muting pattern, a starting resource in the time domain to apply the at least one uplink resource muting pattern, a periodicity to apply the at least one uplink resource muting pattern, a periodicity level to apply the at least one uplink resource muting pattern, an uplink BWP index to apply the at least one uplink resource muting pattern, an SBFD pattern index to apply the at least one uplink resource muting pattern, a panel index to apply the at least one uplink resource muting pattern, or a beam index to apply the at least one uplink resource muting pattern.

Additionally, or alternatively, the UE 600 may be configured to or operable to support the one or more parameters include an offset in at least one of a time domain or a frequency domain based on a downlink transmission associated with the second UE, and to transmit the uplink transmission, the UE 600 may be configured to or operable to support to apply the offset to one or more time or frequency resources associated with the uplink transmission. Additionally, or alternatively, the UE 600 may be configured to or operable to support the one or more parameters include an indication to drop at least one of the uplink transmission or a repetition of the uplink transmission based on the uplink transmission or the repetition of the uplink transmission overlapping with a downlink transmission associated with the second UE, and to transmit the uplink transmission, the UE 600 may be configured to or operable to support to drop at least one of the uplink transmission or the repetition of the uplink transmission. Additionally, or alternatively, the UE 600 may be configured to or operable to support the one or more parameters include a reference priority value that is based on the downlink transmission associated with the second UE, and to drop at least one of the uplink transmission or the repetition of the uplink transmission, the UE 600 may be configured to or operable to support to determine a priority value associated with at least one of the uplink transmission or the repetition of the uplink transmission is greater than the reference priority value.

Additionally, or alternatively, the UE 600 may be configured to or operable to support the one or more parameters include at least one of a power offset value or a maximum transmit power limit, and to transmit the uplink transmission, the UE 600 may be configured to or operable to support to apply at least one of the power offset value or the maximum transmit power limit to a transmit power associated with the uplink transmission. Additionally, or alternatively, the UE 600 may be configured to or operable to support the one or more parameters include at least one of a beam index, a TCI state indicator, or a panel switch indicator, and to transmit the uplink transmission, the UE 600 may be configured to or operable to support to switch at least one of a first panel to a second panel associated with the panel switch indicator or a first uplink transmit beam to a second uplink transmit beam associated with at least one of the beam index or the TCI state indicator. Additionally, or alternatively, the UE 600 may be configured to or operable to support the one or more parameters indicate an update to at least one of an uplink subband time or a frequency dimension associated with the uplink transmission, and to transmit the uplink transmission, the UE 600 may be configured to or operable to support to revert, based on the update, one or more of an uplink RB to a downlink RB corresponding to a downlink transmission associated with the second UE or an SBFD time resource to a non-SBFD time resource.

Additionally, or alternatively, the UE 600 may be configured to or operable to support to receive, prior to the second signaling, third signaling that indicates a set of SBFD patterns, where the one or more parameters include an indication of an SBFD pattern of the set of SBFD patterns that includes one or more first time and frequency resources corresponding to the uplink transmission, and where the SBFD pattern is based on minimizing an overlap between the one or more first time and frequency resources and one or more second time and frequency resources corresponding to a downlink transmission associated with the second UE. Additionally, or alternatively, the UE 600 may be configured to or operable to support to receive, prior to the second signaling, third signaling that indicates a set of uplink BWPs, where the one or more parameters indicate an uplink BWP of the set of uplink BWPs associated with the uplink transmission, and where the uplink BWP is based on minimizing an overlap between one or more first time and frequency resources corresponding to the uplink transmission and one or more second time and frequency resources corresponding to a downlink transmission associated with the second UE. Additionally, or alternatively, the UE 600 may be configured to or operable to support the uplink transmission is transmitted in the at least one uplink subband of the SBFD configuration, where a downlink configuration associated with the second UE overlaps at least in part with the SBFD configuration on the shared TDD carrier, and where the first RAT includes a 6G RAT and the second RAT includes 5G RAT.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

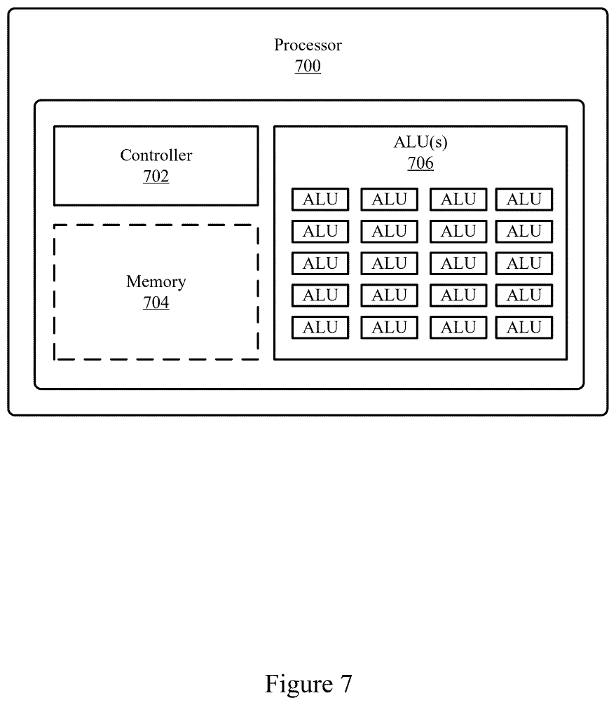

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive first signaling that indicates an SBFD configuration indicating at least one uplink subband and at least one downlink subband associated with a first RAT, where the SBFD configuration operates on a shared TDD carrier associated with the first RAT and a second RAT different from the first RAT, receive second signaling that indicates one or more parameters to minimize an interference between the processor 700 and a UE operating on the shared TDD carrier, where the processor 700 is associated with the first RAT, and where the second UE is associated with the second RAT, and transmit, to an NE associated with the first RAT, an uplink transmission based on the one or more parameters.

Additionally, the processor 700 may be configured to or operable to support any one or combination of the one or more parameters include an indication of at least one uplink resource muting pattern based on one or more time and frequency resources corresponding to a downlink transmission associated with the second UE, and to transmit the uplink transmission, the processor 700 may be configured to or operable to support to mute the uplink transmission on the one or more time and frequency resources. Additionally, or alternatively, the processor 700 may be configured to or operable to support to receive, prior to the second signaling, third signaling that indicates a set of uplink resource muting patterns including the at least one uplink resource muting pattern, and where the one or more parameters include an index corresponding to the at least one uplink resource muting pattern. Additionally, or alternatively, the processor 700 may be configured to or operable to support the at least one uplink resource muting pattern includes one or more bitmaps, an offset in a frequency domain to apply the at least one uplink resource muting pattern, an offset in a time domain to apply the at least one uplink resource muting pattern, a starting resource in the time domain to apply the at least one uplink resource muting pattern, a periodicity to apply the at least one uplink resource muting pattern, a periodicity level to apply the at least one uplink resource muting pattern, an uplink BWP index to apply the at least one uplink resource muting pattern, an SBFD pattern index to apply the at least one uplink resource muting pattern, a panel index to apply the at least one uplink resource muting pattern, or a beam index to apply the at least one uplink resource muting pattern.

Additionally, or alternatively, the processor 700 may be configured to or operable to support the one or more parameters include an offset in at least one of a time domain or a frequency domain based on a downlink transmission associated with the second UE, and to transmit the uplink transmission, the processor 700 may be configured to or operable to support to apply the offset to one or more time or frequency resources associated with the uplink transmission. Additionally, or alternatively, the processor 700 may be configured to or operable to support the one or more parameters include an indication to drop at least one of the uplink transmission or a repetition of the uplink transmission based on the uplink transmission or the repetition of the uplink transmission overlapping with a downlink transmission associated with the second UE, and to transmit the uplink transmission, the processor 700 may be configured to or operable to support to drop at least one of the uplink transmission or the repetition of the uplink transmission. Additionally, or alternatively, the processor 700 may be configured to or operable to support the one or more parameters include a reference priority value that is based on the downlink transmission associated with the second UE, and to drop at least one of the uplink transmission or the repetition of the uplink transmission, the processor 700 may be configured to or operable to support to determine a priority value associated with at least one of the uplink transmission or the repetition of the uplink transmission is greater than the reference priority value. Additionally, or alternatively, the processor 700 may be configured to or operable to support the one or more parameters include at least one of a power offset value or a maximum transmit power limit, and to transmit the uplink transmission, the processor 700 may be configured to or operable to support to apply at least one of the power offset value or the maximum transmit power limit to a transmit power associated with the uplink transmission.

Additionally, or alternatively, the processor 700 may be configured to or operable to support the one or more parameters include at least one of a beam index, a TCI state indicator, or a panel switch indicator, and to transmit the uplink transmission, the processor 700 may be configured to or operable to support to switch at least one of a first panel to a second panel associated with the panel switch indicator or a first uplink transmit beam to a second uplink transmit beam associated with at least one of the beam index or the TCI state indicator. Additionally, or alternatively, the processor 700 may be configured to or operable to support the one or more parameters indicate an update to at least one of an uplink subband time or a frequency dimension associated with the uplink transmission, and to transmit the uplink transmission, the processor 700 may be configured to or operable to support to revert, based on the update, one or more of an uplink RB to a downlink RB corresponding to a downlink transmission associated with the second UE or an SBFD time resource to a non-SBFD time resource.

Additionally, or alternatively, the processor 700 may be configured to or operable to support to receive, prior to the second signaling, third signaling that indicates a set of SBFD patterns, where the one or more parameters include an indication of an SBFD pattern of the set of SBFD patterns that includes one or more first time and frequency resources corresponding to the uplink transmission, and where the SBFD pattern is based on minimizing an overlap between the one or more first time and frequency resources and one or more second time and frequency resources corresponding to a downlink transmission associated with the second UE. Additionally, or alternatively, the processor 700 may be configured to or operable to support to receive, prior to the second signaling, third signaling that indicates a set of uplink BWPs, where the one or more parameters indicate an uplink BWP of the set of uplink BWPs associated with the uplink transmission, and where the uplink BWP is based on minimizing an overlap between one or more first time and frequency resources corresponding to the uplink transmission and one or more second time and frequency resources corresponding to a downlink transmission associated with the second UE. Additionally, or alternatively, the processor 700 may be configured to or operable to support the uplink transmission is transmitted in the at least one uplink subband of the SBFD configuration, where a downlink configuration associated with the second UE overlaps at least in part with the SBFD configuration on the shared TDD carrier, and where the first RAT includes a 6G RAT and the second RAT includes 5G RAT.

The processor 700 may be configured to or operable to support at least one controller (e.g., the controller 702) coupled with at least one memory (e.g., the memory 704) and configured to cause the processor to transmit first signaling that indicates an SBFD configuration indicating at least one uplink subband and at least one downlink subband associated with a first RAT, where the SBFD configuration operates on a shared TDD carrier associated with the first RAT and a second RAT different from the first RAT, transmit second signaling that indicates one or more parameters to minimize an interference between a first UE and a second UE when operating on the shared TDD carrier, where the first UE is associated with the first RAT, and where the second UE is associated with the second RAT, and receive, from the first UE, an uplink transmission based on the one or more parameters, where the processor 700 is associated with the first RAT.

Additionally, the processor 700 may be configured to or operable to support any one or combination of to receive, from an additional NE associated with the second RAT, scheduling information corresponding to a downlink transmission associated with the second UE, and select at least one uplink resource muting pattern based on minimizing an overlap between one or more first time and frequency resource associated with the uplink transmission and one or more second time and frequency resources associated with the downlink transmission, where the one or more parameters indicate the at least one uplink resource muting pattern, and where the uplink transmission is muted on the one or more second time and frequency resources. Additionally, or alternatively, the processor 700 may be configured to or operable to support to transmit, prior to the second signaling, third signaling that indicates a set of uplink resource muting patterns including the at least one uplink resource muting pattern, and where the one or more parameters include an index corresponding to the at least one uplink resource muting pattern. Additionally, or alternatively, the processor 700 may be configured to or operable to support the at least one uplink resource muting pattern includes one or more bitmaps, an offset in a frequency domain to apply the at least one uplink resource muting pattern, an offset in a time domain to apply the at least one uplink resource muting pattern, a starting resource in the time domain to apply the at least one uplink resource muting pattern, a periodicity to apply the at least one uplink resource muting pattern, a periodicity level to apply the at least one uplink resource muting pattern, an uplink BWP index to apply the at least one uplink resource muting pattern, an SBFD pattern index to apply the at least one uplink resource muting pattern, a panel index to apply the at least one uplink resource muting pattern, or a beam index to apply the at least one uplink resource muting pattern.

Additionally, or alternatively, the processor 700 may be configured to or operable to support the one or more parameters include an offset in at least one of a time domain or a frequency domain based on a downlink transmission associated with the second UE, and to receive the uplink transmission, the processor 700 may be configured to or operable to support to apply the offset to one or more time or frequency resources associated with the uplink transmission. Additionally, or alternatively, the processor 700 may be configured to or operable to support the one or more parameters include an indication to drop at least one of the uplink transmission or a repetition of the uplink transmission based on the uplink transmission or the repetition of the uplink transmission overlapping with a downlink transmission associated with the second UE, and at least one of the uplink transmission or the repetition of the uplink transmission is dropped. Additionally, or alternatively, the processor 700 may be configured to or operable to support the one or more parameters include a reference priority value that is based on the downlink transmission associated with the second UE. Additionally, or alternatively, the processor 700 may be configured to or operable to support the one or more parameters include at least one of a power offset value or a maximum transmit power limit. Additionally, or alternatively, the processor 700 may be configured to or operable to support the one or more parameters include at least one of a beam index, a TCI state indicator, or a panel switch indicator.

Additionally, or alternatively, the processor 700 may be configured to or operable to support the one or more parameters indicate an update to at least one of an uplink subband time or a frequency dimension associated with the uplink transmission, and to transmit the uplink transmission, the processor 700 may be configured to or operable to support to revert, based on the update, one or more of an uplink RB to a downlink RB corresponding to a downlink transmission associated with the second UE or an SBFD time resource to a non-SBFD time resource. Additionally, or alternatively, the processor 700 may be configured to or operable to support to transmit, prior to the second signaling, third signaling that indicates a set of SBFD patterns, where the one or more parameters include an indication of an SBFD pattern of the set of SBFD patterns that includes one or more first time and frequency resources corresponding to the uplink transmission, and where the SBFD pattern is based on minimizing an overlap between the one or more first time and frequency resources and one or more second time and frequency resources corresponding to a downlink transmission associated with the second UE. Additionally, or alternatively, the processor 700 may be configured to or operable to support to transmit, prior to the second signaling, third signaling that indicates a set of uplink BWPs, where the one or more parameters indicate an uplink BWP of the set of uplink BWPs associated with the uplink transmission, and where the uplink BWP is based on minimizing an overlap between one or more first time and frequency resources corresponding to the uplink transmission and one or more second time and frequency resources corresponding to a downlink transmission associated with the second UE. Additionally, or alternatively, the processor 700 may be configured to or operable to support the uplink transmission is transmitted in the at least one uplink subband of the SBFD configuration, where a downlink configuration associated with the second UE overlaps at least in part with the SBFD configuration on the shared TDD carrier, and where the first RAT includes a 6G RAT and the second RAT includes 5G RAT.

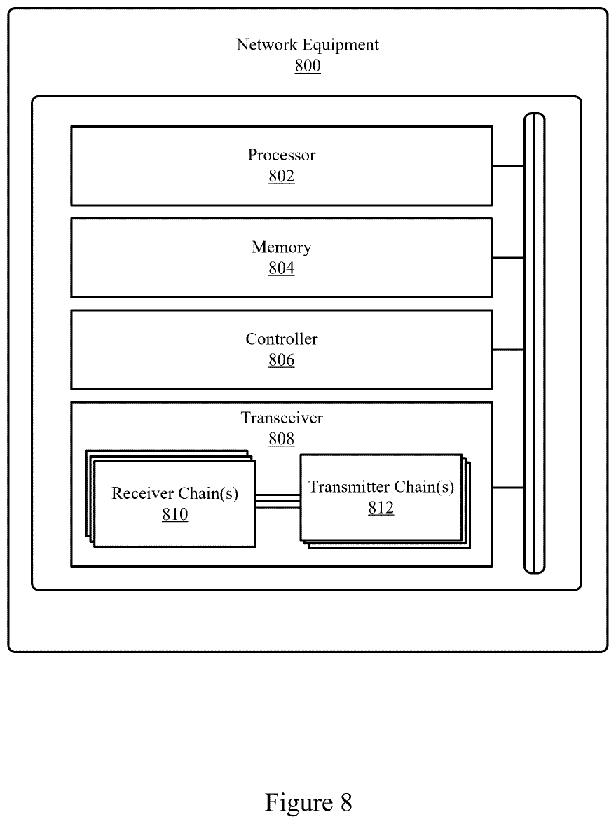

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting first signaling that indicates an SBFD configuration indicating at least one uplink subband and at least one downlink subband associated with a first RAT, where the SBFD configuration operates on a shared TDD carrier associated with the first RAT and a second RAT different from the first RAT, transmitting second signaling that indicates one or more parameters to minimize an interference between a first UE and a second UE when operating on the shared TDD carrier, where the first UE is associated with the first RAT, and where the second UE is associated with the second RAT, and receiving, from the first UE, an uplink transmission based on the one or more parameters, where the NE 800 is associated with the first RAT.

Additionally, the NE 800 may be configured to or operable to support any one or combination of receiving, from an additional NE associated with the second RAT, scheduling information corresponding to a downlink transmission associated with the second UE, and selecting at least one uplink resource muting pattern based on minimizing an overlap between one or more first time and frequency resource associated with the uplink transmission and one or more second time and frequency resources associated with the downlink transmission, where the one or more parameters indicate the at least one uplink resource muting pattern, and where the uplink transmission is muted on the one or more second time and frequency resources. Additionally, or alternatively, the NE 800 may be configured to or operable to support transmitting, prior to the second signaling, third signaling that indicates a set of uplink resource muting patterns including the at least one uplink resource muting pattern, and where the one or more parameters include an index corresponding to the at least one uplink resource muting pattern. Additionally, or alternatively, the NE 800 may be configured to or operable to support the at least one uplink resource muting pattern includes one or more bitmaps, an offset in a frequency domain to apply the at least one uplink resource muting pattern, an offset in a time domain to apply the at least one uplink resource muting pattern, a starting resource in the time domain to apply the at least one uplink resource muting pattern, a periodicity to apply the at least one uplink resource muting pattern, a periodicity level to apply the at least one uplink resource muting pattern, an uplink BWP index to apply the at least one uplink resource muting pattern, an SBFD pattern index to apply the at least one uplink resource muting pattern, a panel index to apply the at least one uplink resource muting pattern, or a beam index to apply the at least one uplink resource muting pattern.

Additionally, or alternatively, the NE 800 may be configured to or operable to support the one or more parameters include an offset in at least one of a time domain or a frequency domain based on a downlink transmission associated with the second UE, and to receive the uplink transmission, applying the offset to one or more time or frequency resources associated with the uplink transmission. Additionally, or alternatively, the NE 800 may be configured to or operable to support the one or more parameters include an indication to drop at least one of the uplink transmission or a repetition of the uplink transmission based on the uplink transmission or the repetition of the uplink transmission overlapping with a downlink transmission associated with the second UE, and at least one of the uplink transmission or the repetition of the uplink transmission is dropped. Additionally, or alternatively, the NE 800 may be configured to or operable to support the one or more parameters include a reference priority value that is based on the downlink transmission associated with the second UE. Additionally, or alternatively, the NE 800 may be configured to or operable to support the one or more parameters include at least one of a power offset value or a maximum transmit power limit. Additionally, or alternatively, the NE 800 may be configured to or operable to support the one or more parameters include at least one of a beam index, a TCI state indicator, or a panel switch indicator.

Additionally, or alternatively, the NE 800 may be configured to or operable to support the one or more parameters indicate an update to at least one of an uplink subband time or a frequency dimension associated with the uplink transmission, and to transmit the uplink transmission, reverting, based on the update, one or more of an uplink RB to a downlink RB corresponding to a downlink transmission associated with the second UE or an SBFD time resource to a non-SBFD time resource. Additionally, or alternatively, the NE 800 may be configured to or operable to support transmitting, prior to the second signaling, third signaling that indicates a set of SBFD patterns, where the one or more parameters include an indication of an SBFD pattern of the set of SBFD patterns that includes one or more first time and frequency resources corresponding to the uplink transmission, and where the SBFD pattern is based on minimizing an overlap between the one or more first time and frequency resources and one or more second time and frequency resources corresponding to a downlink transmission associated with the second UE. Additionally, or alternatively, the NE 800 may be configured to or operable to support transmitting, prior to the second signaling, third signaling that indicates a set of uplink BWPs, where the one or more parameters indicate an uplink BWP of the set of uplink BWPs associated with the uplink transmission, and where the uplink BWP is based on minimizing an overlap between one or more first time and frequency resources corresponding to the uplink transmission and one or more second time and frequency resources corresponding to a downlink transmission associated with the second UE. Additionally, or alternatively, the NE 800 may be configured to or operable to support the uplink transmission is transmitted in the at least one uplink subband of the SBFD configuration, where a downlink configuration associated with the second UE overlaps at least in part with the SBFD configuration on the shared TDD carrier, and where the first RAT includes a 6G RAT and the second RAT includes 5G RAT.

Additionally, or alternatively, the NE 800 may support at least one memory (e.g., the memory 804) and at least one processor (e.g., the processor 802) coupled with the at least one memory and configured to cause the NE to transmit first signaling that indicates an SBFD configuration indicating at least one uplink subband and at least one downlink subband associated with a first RAT, where the SBFD configuration operates on a shared TDD carrier associated with the first RAT and a second RAT different from the first RAT, transmit second signaling that indicates one or more parameters to minimize an interference between a first UE and a second UE when operating on the shared TDD carrier, where the first UE is associated with the first RAT, and where the second UE is associated with the second RAT, and receive, from the first UE, an uplink transmission based on the one or more parameters, where the NE is associated with the first RAT.

Additionally, the NE 800 may be configured to support any one or combination of to receive, from an additional NE associated with the second RAT, scheduling information corresponding to a downlink transmission associated with the second UE, and select at least one uplink resource muting pattern based on minimizing an overlap between one or more first time and frequency resource associated with the uplink transmission and one or more second time and frequency resources associated with the downlink transmission, where the one or more parameters indicate the at least one uplink resource muting pattern, and where the uplink transmission is muted on the one or more second time and frequency resources. Additionally, or alternatively, the NE 800 may be configured to or operable to support to transmit, prior to the second signaling, third signaling that indicates a set of uplink resource muting patterns including the at least one uplink resource muting pattern, and where the one or more parameters include an index corresponding to the at least one uplink resource muting pattern. Additionally, or alternatively, the NE 800 may be configured to or operable to support the at least one uplink resource muting pattern includes one or more bitmaps, an offset in a frequency domain to apply the at least one uplink resource muting pattern, an offset in a time domain to apply the at least one uplink resource muting pattern, a starting resource in the time domain to apply the at least one uplink resource muting pattern, a periodicity to apply the at least one uplink resource muting pattern, a periodicity level to apply the at least one uplink resource muting pattern, an uplink BWP index to apply the at least one uplink resource muting pattern, an SBFD pattern index to apply the at least one uplink resource muting pattern, a panel index to apply the at least one uplink resource muting pattern, or a beam index to apply the at least one uplink resource muting pattern.

Additionally, or alternatively, the NE 800 may be configured to or operable to support the one or more parameters include an offset in at least one of a time domain or a frequency domain based on a downlink transmission associated with the second UE, and to receive the uplink transmission, the NE 800 may be configured to or operable to support to apply the offset to one or more time or frequency resources associated with the uplink transmission. Additionally, or alternatively, the NE 800 may be configured to or operable to support the one or more parameters include an indication to drop at least one of the uplink transmission or a repetition of the uplink transmission based on the uplink transmission or the repetition of the uplink transmission overlapping with a downlink transmission associated with the second UE, and at least one of the uplink transmission or the repetition of the uplink transmission is dropped. Additionally, or alternatively, the NE 800 may be configured to or operable to support the one or more parameters include a reference priority value that is based on the downlink transmission associated with the second UE. Additionally, or alternatively, the NE 800 may be configured to or operable to support the one or more parameters include at least one of a power offset value or a maximum transmit power limit. Additionally, or alternatively, the NE 800 may be configured to or operable to support the one or more parameters include at least one of a beam index, a TCI state indicator, or a panel switch indicator.

Additionally, or alternatively, the NE 800 may be configured to or operable to support the one or more parameters indicate an update to at least one of an uplink subband time or a frequency dimension associated with the uplink transmission, and to transmit the uplink transmission, the NE 800 may be configured to or operable to support to revert, based on the update, one or more of an uplink RB to a downlink RB corresponding to a downlink transmission associated with the second UE or an SBFD time resource to a non-SBFD time resource. Additionally, or alternatively, the NE 800 may be configured to or operable to support to transmit, prior to the second signaling, third signaling that indicates a set of SBFD patterns, where the one or more parameters include an indication of an SBFD pattern of the set of SBFD patterns that includes one or more first time and frequency resources corresponding to the uplink transmission, and where the SBFD pattern is based on minimizing an overlap between the one or more first time and frequency resources and one or more second time and frequency resources corresponding to a downlink transmission associated with the second UE. Additionally, or alternatively, the NE 800 may be configured to or operable to support to transmit, prior to the second signaling, third signaling that indicates a set of uplink BWPs, where the one or more parameters indicate an uplink BWP of the set of uplink BWPs associated with the uplink transmission, and where the uplink BWP is based on minimizing an overlap between one or more first time and frequency resources corresponding to the uplink transmission and one or more second time and frequency resources corresponding to a downlink transmission associated with the second UE. Additionally, or alternatively, the NE 800 may be configured to or operable to support the uplink transmission is transmitted in the at least one uplink subband of the SBFD configuration, where a downlink configuration associated with the second UE overlaps at least in part with the SBFD configuration on the shared TDD carrier, and where the first RAT includes a 6G RAT and the second RAT includes 5G RAT.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., an LNA) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

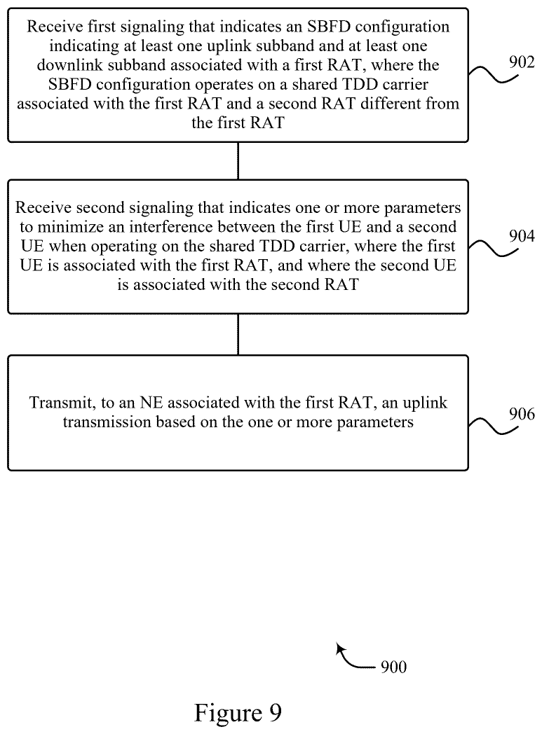

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include receiving first signaling that indicates an SBFD configuration indicating at least one uplink subband and at least one downlink subband associated with a first RAT, where the SBFD configuration operates on a shared TDD carrier associated with the first RAT and a second RAT different from the first RAT. The operations of 902 may be performed in accordance with examples as described herein. In some implementations, aspects of the operations of 902 may be performed by a UE as described with reference to FIG. 6.

At 904, the method may include receiving second signaling that indicates one or more parameters to minimize an interference between the first UE and a second UE when operating on the shared TDD carrier, where the first UE is associated with the first RAT, and where the second UE is associated with the second RAT. The operations of 904 may be performed in accordance with examples as described herein. In some implementations, aspects of the operations of 904 may be performed by a UE as described with reference to FIG. 6.

At 906, the method may include transmitting, to an NE associated with the first RAT, an uplink transmission based on the one or more parameters. The operations of 906 may be performed in accordance with examples as described herein. In some implementations, aspects of the operations of 906 may be performed a UE as described with reference to FIG. 6.

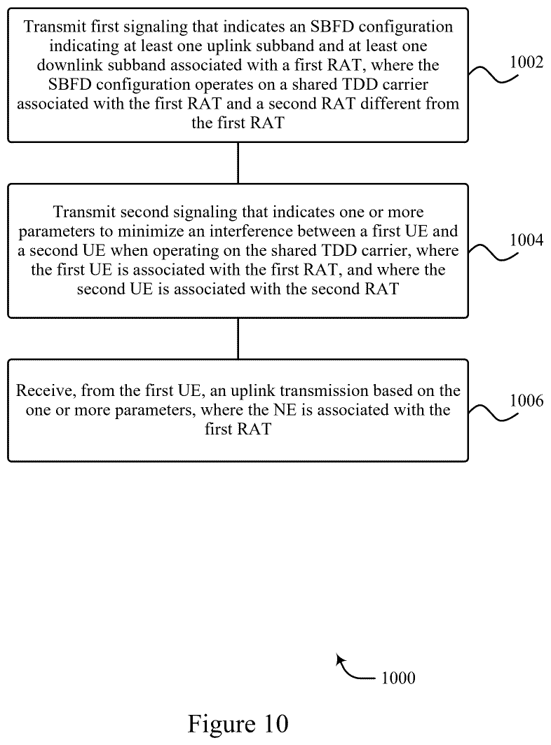

FIG. 10 illustrates a flowchart of a method 1000 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include transmitting first signaling that indicates an SBFD configuration indicating at least one uplink subband and at least one downlink subband associated with a first RAT, where the SBFD configuration operates on a shared TDD carrier associated with the first RAT and a second RAT different from the first RAT. The operations of 1002 may be performed in accordance with examples as described herein. In some implementations, aspects of the operations of 1002 may be performed by an NE as described with reference to FIG. 8.

At 1004, the method may include transmitting second signaling that indicates one or more parameters to minimize an interference between a first UE and a second UE when operating on the shared TDD carrier, where the first UE is associated with the first RAT, and where the second UE is associated with the second RAT. The operations of 1004 may be performed in accordance with examples as described herein. In some implementations, aspects of the operations of 1004 may be performed by an NE as described with reference to FIG. 8.

At 1006, the method may include receiving, from the first UE, an uplink transmission based on the one or more parameters, where the NE is associated with the first RAT. The operations of 1006 may be performed in accordance with examples as described herein. In some implementations, aspects of the operations of 1006 may be performed an NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE) for wireless communication, comprising:
at least one memory; and
at least one processor coupled with the at least one memory and operable to cause the first UE to:
receive first signaling that indicates a subband full duplex (SBFD) configuration indicating at least one uplink subband and at least one downlink subband associated with a first radio access technology (RAT), wherein the SBFD configuration operates on a shared time division duplex (TDD) carrier associated with the first RAT and a second RAT different from the first RAT;
receive second signaling that indicates one or more parameters to minimize an interference between the first UE and a second UE when operating on the shared TDD carrier, wherein the first UE is associated with the first RAT, and wherein the second UE is associated with the second RAT; and
transmit, to a network equipment (NE) associated with the first RAT, an uplink transmission based at least in part on the one or more parameters.

2. The first UE of claim 1, wherein the one or more parameters comprise an indication of at least one uplink resource muting pattern based at least in part on one or more time and frequency resources corresponding to a downlink transmission associated with the second UE, and wherein to transmit the uplink transmission, the at least one processor is operable to cause the first UE to mute the uplink transmission on the one or more time and frequency resources.

3. The first UE of claim 2, wherein the at least one processor is further operable to cause the first UE to receive, prior to the second signaling, third signaling that indicates a plurality of uplink resource muting patterns comprising the at least one uplink resource muting pattern, and wherein the one or more parameters comprise an index corresponding to the at least one uplink resource muting pattern.

4. The first UE of claim 2, wherein the at least one uplink resource muting pattern comprises one or more bitmaps, an offset in a frequency domain to apply the at least one uplink resource muting pattern, an offset in a time domain to apply the at least one uplink resource muting pattern, a starting resource in the time domain to apply the at least one uplink resource muting pattern, a periodicity to apply the at least one uplink resource muting pattern, a periodicity level to apply the at least one uplink resource muting pattern, an uplink bandwidth part (BWP) index to apply the at least one uplink resource muting pattern, an SBFD pattern index to apply the at least one uplink resource muting pattern, a panel index to apply the at least one uplink resource muting pattern, or a beam index to apply the at least one uplink resource muting pattern.

5. The first UE of claim 1, wherein the one or more parameters comprise an indication of an offset in at least one of a time domain or a frequency domain based at least in part on a downlink transmission associated with the second UE, and wherein to transmit the uplink transmission, the at least one processor is operable to cause the first UE to apply the offset to one or more time or frequency resources associated with the uplink transmission.

6. The first UE of claim 1, wherein the one or more parameters comprise an indication to drop at least one of the uplink transmission or a repetition of the uplink transmission based at least in part on the uplink transmission or the repetition of the uplink transmission overlapping with a downlink transmission associated with the second UE, and wherein to transmit the uplink transmission, the at least one processor is operable to cause the first UE to drop at least one of the uplink transmission or the repetition of the uplink transmission.

7. The first UE of claim 6, wherein the one or more parameters comprise an indication of a reference priority value that is based at least in part on the downlink transmission associated with the second UE, and wherein to drop at least one of the uplink transmission or the repetition of the uplink transmission, the at least one processor is operable to cause the first UE to determine a priority value associated with at least one of the uplink transmission or the repetition of the uplink transmission is greater than the reference priority value.

8. The first UE of claim 1, wherein the one or more parameters comprise an indication of at least one of a power offset value or a maximum transmit power limit, and wherein to transmit the uplink transmission, the at least one processor is operable to cause the first UE to apply at least one of the power offset value or the maximum transmit power limit to a transmit power associated with the uplink transmission.

9. The first UE of claim 1, wherein the one or more parameters comprise an indication of at least one of a beam index, a transmission configuration indicator (TCI) state indicator, or a panel switch indicator, and wherein to transmit the uplink transmission, the at least one processor is operable to cause the first UE to switch at least one of a first panel to a second panel associated with the panel switch indicator or a first uplink transmit beam to a second uplink transmit beam associated with at least one of the beam index or the TCI state indicator.

10. The first UE of claim 1, wherein the one or more parameters comprise an indication of an update to at least one of an uplink subband time or a frequency dimension associated with the uplink transmission, and wherein to transmit the uplink transmission, the at least one processor is operable to cause the first UE to revert, based at least in part on the update, one or more of an uplink resource block to a downlink resource block corresponding to a downlink transmission associated with the second UE or an SBFD time resource to a non-SBFD time resource.

11. The first UE of claim 1, wherein the at least one processor is further operable to cause the first UE to receive, prior to the second signaling, third signaling that indicates a plurality of SBFD patterns, wherein the one or more parameters comprise an indication of an SBFD pattern of the plurality of SBFD patterns that comprises one or more first time and frequency resources corresponding to the uplink transmission, and wherein the SBFD pattern is based at least in part on minimizing an overlap between the one or more first time and frequency resources and one or more second time and frequency resources corresponding to a downlink transmission associated with the second UE.

12. The first UE of claim 1, wherein to transmit the uplink transmission, the at least one processor is further operable to cause the first UE to receive, prior to the second signaling, third signaling that indicates a plurality of uplink bandwidth parts (BWPs), wherein the one or more parameters indicate an uplink BWP of the plurality of uplink BWPs associated with the uplink transmission, and wherein the uplink BWP is based at least in part on minimizing an overlap between one or more first time and frequency resources corresponding to the uplink transmission and one or more second time and frequency resources corresponding to a downlink transmission associated with the second UE.

13. The first UE of claim 1, wherein the uplink transmission is transmitted in the at least one uplink subband of the SBFD configuration, wherein a downlink configuration associated with the second UE overlaps at least in part with the SBFD configuration on the shared TDD carrier, and wherein the first RAT comprises a sixth generation (6G) RAT and the second RAT comprises fifth generation (5G) RAT.

14. A method performed by a first user equipment (UE), the method comprising:
receiving first signaling that indicates a subband full duplex (SBFD) configuration indicating at least one uplink subband and at least one downlink subband associated with a first radio access technology (RAT), wherein the SBFD configuration operates on a shared time division duplex (TDD) carrier associated with the first RAT and a second RAT different from the first RAT;
receiving second signaling that indicates one or more parameters to minimize an interference between the first UE and a second UE when operating on the shared TDD carrier, wherein the first UE is associated with the first RAT, and wherein the second UE is associated with the second RAT; and
transmitting, to a network equipment (NE) associated with the first RAT, an uplink transmission based at least in part on the one or more parameters.

15. A network equipment (NE) for wireless communication, comprising:
at least one memory; and
at least one processor coupled with the at least one memory and operable to cause the NE to:
transmit first signaling that indicates a subband full duplex (SBFD) configuration indicating at least one uplink subband and at least one downlink subband associated with a first radio access technology (RAT), wherein the SBFD configuration operates on a shared time division duplex (TDD) carrier associated with the first RAT and a second RAT different from the first RAT;
transmit second signaling that indicates one or more parameters to minimize an interference between a first user equipment (UE) and a second UE when operating on the shared TDD carrier, wherein the first UE is associated with the first RAT, and wherein the second UE is associated with the second RAT; and
receive, from the first UE, an uplink transmission based at least in part on the one or more parameters, wherein the NE is associated with the first RAT.

16. The NE of claim 15, wherein the at least one processor is further operable to cause the NE to:
receive, from an additional NE associated with the second RAT, scheduling information corresponding to a downlink transmission associated with the second UE; and
select at least one uplink resource muting pattern based at least in part on minimizing an overlap between one or more first time and frequency resource associated with the uplink transmission and one or more second time and frequency resources associated with the downlink transmission, wherein the one or more parameters comprise an indication of the at least one uplink resource muting pattern, and wherein the uplink transmission is muted on the one or more second time and frequency resources.

17. The NE of claim 15, wherein the one or more parameters comprise an indication of an offset in at least one of a time domain or a frequency domain based at least in part on a downlink transmission associated with the second UE, and wherein to receive the uplink transmission, the at least one processor is operable to cause the NE to apply the offset to one or more time or frequency resources associated with the uplink transmission.

18. The NE of claim 15, wherein the one or more parameters comprise an indication to drop at least one of the uplink transmission or a repetition of the uplink transmission based at least in part on the uplink transmission or the repetition of the uplink transmission overlapping with a downlink transmission associated with the second UE, and wherein at least one of the uplink transmission or the repetition of the uplink transmission is dropped.

19. The NE of claim 15, wherein the at least one processor is further operable to cause the NE to transmit, prior to the second signaling, third signaling that indicates a plurality of SBFD patterns, wherein the one or more parameters comprise an indication of an SBFD pattern of the plurality of SBFD patterns that comprises one or more first time and frequency resources corresponding to the uplink transmission, and wherein the SBFD pattern is based at least in part on minimizing an overlap between the one or more first time and frequency resources and one or more second time and frequency resources corresponding to a downlink transmission associated with the second UE.

20. A method performed by a network equipment (NE), the method comprising:
transmitting first signaling that indicates a subband full duplex (SBFD) configuration indicating at least one uplink subband and at least one downlink subband associated with a first radio access technology (RAT), wherein the SBFD configuration operates on a shared time division duplex (TDD) carrier associated with the first RAT and a second RAT different from the first RAT;
transmitting second signaling that indicates one or more parameters to minimize an interference between a first user equipment (UE) and a second UE when operating on the shared TDD carrier, wherein the first UE is associated with the first RAT, and wherein the second UE is associated with the second RAT; and
receiving, from the first UE, an uplink transmission based at least in part on the one or more parameters, wherein the NE is associated with the first RAT.
